(19) United States
(12) Patent Application Publication
(10) Pub. No.: US 2026/0105455 A1
(43) Pub. Date: Apr. 16, 2026

(54) VEHICLE BASED ELECTRONIC COMMUNICATION AND AUTHENTICATION SYSTEMS

(71) Applicant: U.S. BANK NATIONAL ASSOCIATION, Minneapolis, MN (US)

(72) Inventors: Storm Tuchek, Acworth, GA (US); Cody Roemhildt, Lakeville, MN (US)

(21) Appl. No.: 18/916,132

(22) Filed: Oct. 15, 2024

(51) Int. Cl. G06Q 20/40; B60W 40/08

(52) U.S. Cl. CPC G06Q 20/40155; B60W 40/08; B60W 2040/0809

(57) ABSTRACT

Improved vehicles and electronic communication systems are provided. A registered user is a user recognized as a registered user by at least a transactional system. A registered user can further include a dual-registered user that is further registered with a vehicle system. The registered user identifier is associated with a driver, a vehicle, and a registered user of the transactional system. An authentication score is generated indicating a likelihood that a current driver identity associated with current vehicle sensor data matches one or more subject identities. A secure communication session is established and a transaction is executed that can involve a dispensing system. Transaction data can be transmitted via a first communication protocol, and further through another communication protocol to enable secure vehicle-based transactions. Authentication and transactions can be executed upon a vehicle arriving on the premises of an establishment. Instructions and confirmations are provided via a vehicle system.

### FIELD

The present application is generally related to systems, methods, apparatuses, and computer program products associated with vehicle systems and electronic communication systems.

### BACKGROUND

Users are increasingly using alternative methods of interacting with various establishments, a trend which appears to have accelerated during and following the COVID-19 pandemic. However, security risks, unreliability, inaccuracy, and slower time to execution hamper the effectiveness of such alternative systems. Through applied effort, ingenuity, and innovation, these processes are improved by developing solutions that are configured in accordance with the embodiments of the present disclosure, many examples of which are described in detail herein.

### SUMMARY

Various embodiments are directed to apparatuses, methods, systems, and related computer readable media related to vehicle communications, secure authentication, and transactional processes and systems facilitated thereby.

A system is provided including a vehicle, a driver authentication apparatus and a transactional system. The vehicle includes at least one user input device configured to receive a user input, at least one sensor configured to generate one or more vehicle sensor data objects, and a vehicle transceiver configured to transmit the at least one vehicle sensor data object directly or indirectly to an authentication system.

The at least one driver authentication apparatus includes one or more processors and at least one non-transitory memory having instructions that, when executed by the one or more processors, cause the one or more processors to receive a first identifier associated with a registered user associated with a driver and a vehicle, receive the one or more vehicle sensor data objects associated with the registered user, and generate a driver authentication model based on the one or more vehicle sensor data objects and the first identifier associated with the registered user.

The least one non-transitory memory of the drive authentication apparatus further includes instructions that, when executed by the one or more processors, cause the one or more processors to receive an authentication request data object via one or more external devices, wherein the authentication request data object comprises one or more subject user identifiers associated with one or more subject identities, including the driver, and receive one or more current vehicle sensor data objects generated by the at least one sensor of the vehicle.

The least one non-transitory memory of the drive authentication apparatus further includes instructions that, when executed by the one or more processors, cause the one or more processors to generate, via the driver authentication model and based on the one or more current vehicle sensor data objects, an authentication score, the authentication score indicative of a likelihood that the one or more current vehicle sensor data objects matches the driver associated with the first identifier, and transmit an authentication success indication in an instance in which the authentication score indicates a match between the one or more current vehicle sensor data objects matches the driver associated with the first identifier.

The transactional system includes one or more processors and at least one non-transitory memory having instructions that, when executed by the one or more processors, cause the one or more processors to receive an indication of the user input via the at least one user input device of the vehicle, generate an authentication request data object based on the at least one user input, transmit the authentication request data object to the at least one driver authentication apparatus, receive the authentication success indication from the at least one driver authentication apparatus, and based on the authentication success indication, causing a dispensing device to output a physical transaction output.

In response to the authentication success indication, the at least one transactional system is configured to apply a reduced security protocol to the transaction, and in response to an authentication failure indication, apply a standard security protocol to a transaction, wherein the reduced security protocol comprises at least one fewer security input than the standard security protocol.

A system is provided, comprising one or more processors and at least one non-transitory memory having instructions that, when executed by the one or more processors, cause the one or more processors to receive a first identifier associated with a registered user associated with a driver and a vehicle, receive one or more vehicle sensor data objects generated via at least one sensor of the vehicle and associated with the registered user, generate a driver authentication model based on the one or more vehicle sensor data objects and the first identifier associated with the registered user, receive an authentication request data object, and receive one or more current vehicle sensor data objects generated by the at least one sensor of the vehicle.

The one or more processors and at least one non-transitory memory further include instructions that, when executed by the one or more processors, cause the one or more processors to generate, via the driver authentication model and based on the one or more current vehicle sensor data objects, an authentication score, the authentication score indicative of a likelihood that the one or more current vehicle sensor data objects matches the driver associated with the first identifier, and transmit an authentication success indication in an instance in which the authentication score indicates a match between the one or more current vehicle sensor data objects matches the driver associated with the first identifier.

The one or more vehicle sensor data objects may be generated based on a plurality of vehicle trips, each associated with the driver. The first identifier is received via a mobile device in the vehicle and wherein the instructions, that when executed by the one or more processors, further cause the one or more processors to generate one or more labels based at least on the first identifier received via the mobile device, update the driver authentication model with the one or more labels, and train the driver authentication model to generate the authentication score.

The system, that when executed by the one or more processors, further cause the one or more processors to generate one or more labels based at least on the one or more vehicle sensor data objects, update the driver authentication model with the one or more labels, and train the driver authentication model to generate the authentication score. The authentication request data object comprises one or more subject user identifiers associated with one or more subject identities, including the driver. The authentication request data object is received from one or more external devices comprising at least one of a transactional system device, a vehicle system device, a dispensing control system, a payment server, a terminal, a vehicle detection system, a gateway control system, or an on-premises transceiver. The at least one of the one or more vehicle sensor data objects or the one or more current vehicle sensor data objects comprise weight sensor data generated via a weight sensor in a seat of the vehicle.

The at least one of the one or more vehicle sensor data objects or the one or more current vehicle sensor data objects comprise location data. The at least one of the one or more vehicle sensor data objects or the one or more current vehicle sensor data objects comprise at least one of acceleration data, speed data, or steering data generated by the vehicle. The authentication score is generated further based on additional data received from a mobile device. The additional data comprises location data received via the mobile device. The authentication score is generated further based on additional data received from a vehicle detection system.

A computer-implemented method is provided, including receiving a first identifier associated with a registered user associated with a driver and a vehicle, receiving one or more vehicle sensor data objects generated via at least one sensor of the vehicle and associated with the registered user, and generating a driver authentication model based on the one or more vehicle sensor data objects and the first identifier associated with the registered user. The computer-implemented method further includes receiving an authentication request data object, receiving one or more current vehicle sensor data objects generated by the at least one sensor of the vehicle, generating, via the driver authentication model and based on the one or more current vehicle sensor data objects, an authentication score, the authentication score indicative of a likelihood that the one or more current vehicle sensor data objects matches the driver associated with the first identifier, and transmitting an authentication success indication in an instance in which the authentication score indicates a match between the one or more current vehicle sensor data objects matches the driver associated with the first identifier.

A system is provided including one or more processors and at least one non-transitory memory having instructions that, when executed by the one or more processors, cause the one or more processors to receive an authentication request data object, receive one or more current vehicle sensor data objects generated by at least one or more vehicle sensors of a vehicle, apply the one or more current vehicle sensor data objects to a driver authentication model to determine an authentication score, the authentication score indicative of a likelihood that the one or more current vehicle sensor data objects matches a subject identity, and in a circumstance the authentication score satisfies a predetermined threshold, establish a secure communication session between at least one of (a) a mobile device or (b) a vehicle system of the vehicle, and an external device.

The instructions, that when executed by the one or more processors, further cause the one or more processors to, in a circumstance the authentication score does not satisfy the predetermined threshold, perform at least one of: (a) preventing, at least temporality, establishment of the secure communication session, or (b) initiating a supplemental authentication procedure. The instructions, that when executed by the one or more processors, further cause the one or more processors to, further in the circumstance the authentication score satisfies the predetermined threshold, execute a transaction via the external device.

The authentication request data object is received via at least one of a mobile device, the vehicle system, the external device, or a vehicle detection system. The instructions, that when executed by the one or more processors, further cause the one or more processors to receive a detected vehicle data object, wherein the authentication request data object is generated in response to receiving the detected vehicle data object. Further in the circumstance the authentication score satisfies the predetermined threshold, the secure communication session is configured to trigger dispensing of a product or currency at a dispensing device. Further in the circumstance the authentication score satisfies the predetermined threshold, the secure communication session enables user interaction via at least one of (a) the mobile device or (b) a vehicle-based user device of the vehicle system, and the external device. The instructions, that when executed by the one or more processors, further cause the one or more processors to, at a first time instance, receive a transaction initiation data object, and at a second time instance after the first time instance, receive a detected vehicle data object associated with the transaction initiation data object, wherein the authentication request data object is generated in response to receiving the detected vehicle data object.

A computer-implemented method is provided, including receiving an authentication request data object, receiving one or more current vehicle sensor data objects generated by at least one or more vehicle sensors of a vehicle, applying the one or more current vehicle sensor data objects to a driver authentication model to determine an authentication score, the authentication score indicative of a likelihood that the one or more current vehicle sensor data objects matches a subject identity, and in a circumstance the authentication score satisfies a predetermined threshold, establishing a secure communication session between at least one of (a) a mobile device or (b) a vehicle system of the vehicle, and an external device.

The computer-implemented method further includes, in a circumstance the authentication score does not satisfy the predetermined threshold, performing at least one of: (a) preventing, at least temporality, establishment of the secure communication session, or (b) initiating a supplemental authentication procedure. The computer-implemented method further includes in the circumstance the authentication score satisfies the predetermined threshold, executing a transaction via the external device. The computer-implemented method further includes receiving a detected vehicle data object, wherein the authentication request data object is generated in response to receiving the detected vehicle data object.

A computer program product is provided, comprising at least one non-transitory computer-readable storage medium having computer-executable program code instructions stored therein, the computer-executable program code instructions comprising program code instructions to receive an authentication request data object, receive one or more current vehicle sensor data objects generated by at least one or more vehicle sensors of a vehicle, apply the one or more current vehicle sensor data objects to a driver authentication model to determine an authentication score, the authentication score indicative of a likelihood that the one or more current vehicle sensor data objects matches a subject identity, and, in a circumstance the authentication score satisfies a predetermined threshold, establish a secure communication session between at least one of (a) a mobile device or (b) a vehicle system of the vehicle, and an external device.

An apparatus is provided including one or more processors and at least one non-transitory memory having instructions that, when executed by the one or more processors, cause the one or more processors to receive a vehicle-transmitted transaction data object at an on-premises transceiver of the apparatus via a first wireless communication protocol, wherein the vehicle-transmitted transaction data object is transmitted from a vehicle transceiver to the on-premises transceiver of the apparatus, generate an on-premises transaction data object based on the vehicle-transmitted transaction data object, and transmit the on-premises transaction data object to a transactional system via a long-range communication protocol.

The instructions, that when executed by the one or more processors, further cause the one or more processors to receive a vehicle position data object, wherein the vehicle position data object is generated based at least on data transmitted from a vehicle transceiver to an on-premises transceiver via at least the first wireless communication protocol. The instructions, that when executed by the one or more processors, further cause the one or more processors to transmit the vehicle position data object to the transactional system. The vehicle-transmitted transaction data object is based on user input data received via at least one of a mobile device or a vehicle-transmitted user device. According to certain embodiments, the first wireless communication protocol comprises an ultra-wideband (UWB) communication protocol.

The instructions, that when executed by the one or more processors, further cause the one or more processors to receive one or more current vehicle sensor data objects, wherein an authentication score is generated based at least on the one or more current vehicle sensor data objects. The vehicle-transmitted transaction data object includes payment data and is configured in a first format associated with the first wireless communication protocol, and the on-premises transaction data object is configured in a second format associated with the long-range communication protocol.

A computer-implemented method is provided, including receiving a vehicle-transmitted transaction data object at an on-premises transceiver via a first wireless communication protocol, wherein the vehicle-transmitted transaction data object is transmitted from a vehicle transceiver to the on-premises transceiver, generating an on-premises transaction data object based on the vehicle-transmitted transaction data object, and transmitting the on-premises transaction data object to a transactional system via a long-range communication protocol. The computer-implemented method further includes receiving a vehicle position data object, wherein the vehicle position data object is generated based at least on data transmitted from a vehicle transceiver to an on-premises transceiver via at least the first wireless communication protocol.

A system comprising one or more processors and at least one non-transitory memory having instructions that, when executed by the one or more processors, cause the one or more processors to receive, via a vehicle transceiver, and via an ultra-wideband (UWB) communication protocol, a communication request data object from an on-premises transceiver, and in response to receiving the communication request data object, cause transmission of a vehicle-transmitted transaction data object to the on-premises transceiver via the UWB communication protocol.

The instructions, that when executed by the one or more processors, further cause the one or more processors to, further in response to receiving the communication request data object, generate a vehicle position data object and cause transmission of the vehicle position data object to the on-premises transceiver via the UWB communication protocol.

The instructions, that when executed by the one or more processors, further cause the one or more processors to, further in response to receiving the communication request data object, generate an authentication request data object and cause transmission of the authentication request data object to the on-premises transceiver via the UWB communication protocol. The instructions, that when executed by the one or more processors, further cause the one or more processors to generate an authentication score using one or more current vehicle sensor data objects, wherein the vehicle-transmitted transaction data object is transmitted to the on-premises transceiver via the UWB communication protocol in a circumstance the authentication score satisfies a predetermined threshold. The instructions, that when executed by the one or more processors, further cause the one or more processors to perform at least one of searching for or transmitting a signal via the UWB communication protocol.

A computer-implemented method is provided, comprising receiving, via a vehicle transceiver, and via an ultra-wideband (UWB) communication protocol, a communication request data object from an on-premises transceiver, and in response to receiving the communication request data object, cause transmission of a vehicle-transmitted transaction data object to the on-premises transceiver via the UWB communication protocol. The method further includes, in response to receiving the communication request data object, generating a vehicle position data object and cause transmission of the vehicle position data object to the on-premises transceiver via the UWB communication protocol.

The computer-implemented method further includes, further in response to receiving the communication request data object, generating an authentication request data object and cause transmission of the authentication request data object to the on-premises transceiver via the UWB communication protocol. The computer-implemented method further includes generating an authentication score using one or more current vehicle sensor data objects, wherein the vehicle-transmitted transaction data object is transmitted to the on-premises transceiver via the UWB communication protocol in a circumstance the authentication score satisfies a predetermined threshold. The method may further include performing at least one of searching for or transmitting a signal via the UWB communication protocol.

Other embodiments include corresponding systems, methods, and computer programs, configured to perform the operations of the apparatus, encoded on computer storage devices. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Having thus described some embodiments in general terms, references will now be made to the accompanying drawings, which are not drawn to scale, and wherein:

FIG. 1 illustrates an example system according to various embodiments of the present disclosure.

FIG. 2 discloses an example computing environment with which aspects of the present disclosure may be implemented.

FIGS. 3, 4A, and 5 are signal diagrams according to various embodiments of the present disclosure.

FIG. 4B illustrates an example transaction process according to various embodiments of the present disclosure.

FIG. 6 illustrates an example machine learning framework according to various embodiments of the present disclosure.

FIG. 7 illustrates an example transaction process according to various embodiments of the present disclosure.

FIG. 8 is an illustration of a scenario according to various embodiments of the present disclosure.

FIG. 9 is an example user interface display of a vehicle-based user interface according to various embodiments of the present disclosure.

FIG. 10 illustrates an example transaction process according to various embodiments of the present disclosure.

FIGS. 11-12 are example user interface displays of a vehicle-based user interface according to various embodiments of the present disclosure.

FIG. 13 illustrates an example transaction process according to various embodiments of the present disclosure.

FIGS. 14-15 are example user interface displays of a vehicle-based user interface according to various embodiments of the present disclosure.

FIG. 16 is an example user interface display of a user device according to various embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout.

### Overview

Users are increasingly using alternative methods of interacting with various establishments other than walking into a physical establishment premises and interacting with employees or devices within the establishment. Current systems are unable to handle these alternative methods effectively, leading to poor security, poor user experience, inaccuracy, and slow transaction execution time. For example, a customer user (referred to as a “user” or “customer” herein) may physically interact with an external establishment device, such as an ATM, to perform a transaction. However, these processes require physical interaction with an external machine, requiring the user to leave their vehicle or reach out of a vehicle for extended time while going through an authentication process (e.g., presenting a card and personal identification number (PIN)). Similarly, drive up or drive through establishments require either direct physical interaction (e.g., with an establishment employee, such as through a window, pneumatic tube system, or at a counter) or interaction via a mobile device, such as by the user calling or messaging the establishment. Systems which may attempt to simply automate these processes suffer from similar drawbacks compounded with the additional problems of software and hardware issues (e.g., calls and messages not being received, phone apps not connecting, security overhead, etc.). Moreover, with some traditional, purely mobile systems (e.g., mobile app based purchase and pickup), the physical location of the establishment may be unable to efficiently detect the user's arrival at the location, may be unable to identify the user amongst other users at the location, may depend upon third party and/or indirect authentication processes, and/or may require inaccurate or unreliable combinations of hardware and software interaction (e.g., calling a customer service desk to notify the location of the user's arrival).

Some transactional systems may require indirect physical and/or information-based security processes, such as presenting a card and/or entering an authentication code or password. In some instances, using processes such as two factor authentication, an additional device (e.g., a user's phone) may provide a second, indirect security feature to increase the protection of the system at the cost of additional time. These systems may lack any direct process for verifying the identity of the user, and instead verify the authenticity of the security features (e.g., a credit or debit card) and trust that the user is the only one with access to the security features. Layering these security features may provide additional protection (e.g., a card plus a PIN, an account login plus an email, etc.).

Certain embodiments of the present disclosure relate to processes, systems, methods, and apparatuses for integrating vehicle hardware and software systems into a transaction process for enhanced security, efficiency, accuracy, and convenience. In some embodiments, the vehicle may include one or more sensors according to the embodiments discussed herein,. The sensors may, for example when combined with one or more driver authentication apparatuses performing processes described herein, facilitate direct verification of the identity of a driver of the vehicle. This direct verification may be used with various embodiments of transactional systems, apparatuses, and processes described herein to facilitate one or more types of transaction. According to certain embodiments, advantageously utilizing data from the vehicle provides a higher level of authentication than traditional systems with increased speed, accuracy, and efficiency and reduced individual involvement.

Example embodiments may create a driver authentication model associated with a user (e.g., a driver of a vehicle) over time, and the system may be called (e.g., via API) to authenticate a driver of a vehicle at a specific given time based on the driver authentication model. The model may be built using one or more vehicle sensors to generate vehicle sensor data. In some embodiments, the vehicle sensors may be integral with or in communication with an electric control unit (ECU) of the vehicle, including those discussed herein, such as an in-seat weight sensor, a steering wheel contact sensor, a throttle position sensor, g-force sensor, or the like. The vehicle sensors may additionally or alternatively include or other vehicle-based sensors, such as standalone sensor devices placed in or on the vehicle. In some embodiments, the model may define a biometric identity profile that may be compared with current vehicle sensor data to verify the identity of a current driver of the vehicle. Similar processes may be used for any occupant of a vehicle. This authentication system may be exposed for interaction with other processes, apparatuses, and systems, for real time or near real time authentication of the identity of a driver of a vehicle. For example, the authentication system may be used as an alternative or additional tool for verifying the identity of a user when starting or operating a vehicle (e.g., as an alternative or addition to a car key). The authentication system may operate passively from the perspective of the user, such as by collecting the sensor data and during normal operation of the vehicle, generating and/or updating the model automatically, and responding to authentication requests automatically, semi-automatically, or, in some embodiments, manually upon approval by the user at an interface.

Once this connection and authentication is established via API or similar computer interface, users can execute secure transactions. In some embodiments, the secure transactional systems may be integrated with or otherwise connected to the vehicle system to allow the user to execute the transaction from their vehicle. For example, a vehicle system may include an integral display (e.g., an infotainment display) and/or may communicate data (e.g., in image or textual form) to an external display (e.g., a user's mobile device) to interact with a software application (e.g., an app installed on the vehicle, mobile device, or combination thereof such as a CARPLAY system by APPLE or an ANDROID AUTO system by GOOGLE) to facilitate secure transactions faster, more securely, more accurately, and more conveniently than traditional systems.

As non-limiting examples, various systems, apparatuses, and methods disclosed herein may utilize in-car controls (e.g., touch-screen commands, voice commands, text commands, or the like) to submit money orders, order checks, withdraw cash, navigate to the closest ATM, and other services from inside a vehicle. Portions of the transactions requiring external interaction (e.g., receiving cash) may minimize other authentication and other interaction steps via the embodiments of secure authentication systems, apparatuses, and processes described herein and/or via the embodiments of transactional systems, apparatuses, and processes described herein. For example, a transactional system may communicate with the network of bank branches and partner ATMs to notify the user of their options of transaction type and other related options. For example, the user may be able to select between ATM visits, mobile pick-up lanes with pneumatic tube delivery, and physical pick-up lockers, each of which may include various processes for transaction execution discussed herein. Various embodiments discussed herein may also facilitate a user initiating part of a transaction before arriving at a physical location associated with the transaction (e.g., ordering food, requesting cash, etc. while at another location), after which the systems discussed herein may facilitate navigation to the corresponding physical location and execution of the transaction.

Once the user arrives at the physical location (e.g., a bank, restaurant, etc.), a system associated with the physical location (e.g., a transactional system or portion thereof) detects the user and/or the vehicle and facilitates completion of the transaction. In some embodiments, the transactional system may use geofencing, such that, by entering an established geofence, sensors will confirm the identity of the user through a combination of the aforementioned authentication system and vehicle identification. For example, the identification may include using, for example, license plate and VIN scans, GPS sensors on the vehicle and/or a user mobile device, etc. The authentication system may use the aforementioned driver authentication model in combination with current sensor signals to verify the driver's identity. For example, the biometric profile built by the authentication system as the model may verify directly detectable indicia of the driver's identity, such as driver weight and/or driving habits. The current sensor data may be received at or proximate the time of execution of the transaction (e.g., upon submission of the transaction off-site, upon arrival at the physical location, upon approaching a device at the physical location, or the like, including at any time specified in the corresponding software used by the user to execute the transaction). Any or all non-physical interactions may be carried out within the vehicle via the aforementioned displays and embodiments discussed herein. For example, customers may enter their PIN and interface with bank platforms directly on their vehicle's visual display. Services will be dispensed physically and/or electronically, and then the secure connection between the customer's vehicle and the bank or other establishment will be closed.

Various embodiments also include system, apparatuses, and processes for locally identifying a user vehicle and executing a transaction. For example, according to certain embodiments, a connected vehicle transactional system may include a vehicle interacting with a terminal physically disposed at the physical location of the establishment. The terminal may establish, in some embodiments, a first wireless connection with the vehicle and a second wireless connection with another system associated with the establishment and/or the transaction. For example, the system may facilitate a payment between the vehicle and an establishment through an ultra-wideband (UWB) and/or long range (LoRa) enabled terminal. For example, a terminal may facilitate detection of the location of the particular user's vehicle (e.g., via UWB wireless communication), and the terminal may connect the vehicle with the establishment via a LoRa network.

A terminal in accordance with various embodiments of the present disclosure may eliminate the need for a separate transaction execution device (e.g., phone, credit card, etc.), and may improve accuracy and speed of the transaction. In some embodiments, a terminal may further enable improved communication directly with the customer, for example, by facilitating online ordering through voice technology. Example embodiments may utilize an outdoor-UWB and/or LoRa enabled terminal in combination with the other systems, apparatuses, and processes described herein. For example, the transactional system may further interact with a driver authentication apparatus for authenticating the driver of the vehicle connected to the terminal. Passive customer biometric authentication and the ability to interface with a terminal directly from the vehicle may reduce the need for separate security processes or devices in order to complete a transaction without reducing the security of the transaction. The combination of a payment terminal and UWB and LoRa technology may enable a transaction experience outside of a Wi-Fi connected building or other traditional wireless communication technology.

Additionally, in some embodiments, example embodiments may provide a further improved level of transaction efficiency by utilizing user purchasing and/or driving habits and/or otherwise improved security by using one or more vehicle sensor data objects to identify users. Various embodiments of the present disclosure may additionally reduce the need to interface with a separate device, such a drive-up touch screen installed on-site, when transacting from a vehicle. In some embodiments, the improved authentication may be used to improve user privacy and privacy compliance by facilitating the grant of user location access to an establishment with guaranteed verification of the driver's identity prior to the transmission of such location data to the establishment. As such, in some embodiments, establishments may receive more detailed information about user location, enabling smoother physical location interaction. Numerous variations, combinations, features, and sub-features of the above examples can be contemplated according to embodiments disclosed herein.

### Example Terminology

As used herein, the terms “data,” “content,” “digital content,” “digital content object,” “information,” and similar terms may be used interchangeably to refer to data capable of being transmitted, received, and stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and the like.

The term “transaction” refers to an identifiable, non-transitory occurrence that has technical significance for one or both of system hardware and software. A transaction can include transmission of a transaction data object to another computing entity. In some instances, transaction is associated with an authenticated and secure event that can have an associated underlying monetary significance or value. A transaction can be related to an approval of a purchase, withdrawal of funds, opening of a secure locker, and the like.

The term “transaction data object” refers to electronic data pertaining to a transaction and can include but is not limited to a vehicle-transmitted transaction data object and an on-premises transaction data object. A transaction data object can include an amount such as a dollar amount, cardholder information, date and time, merchant information, a user identifier, transaction instructions, and/or other information. Each transaction may include one or more transaction data object which may comprise data used for one or more steps of the transaction.

The term “transaction initiation data object” refers to an identifiable, non-transitory occurrence that has technical significance for one or both of system hardware and software. The transaction initiation data object is associated with an instruction or request to conduct a transaction. The transaction initiation data object can include any data relating to the intent or request and can further include one or more subject user identifiers associated with a subject identity. The transaction initiation data object may be generated by a vehicle system or user device or in response to trigger signals sent by a vehicle system or user device. The transaction initiation data object can be transmitted from a user device, mobile device, vehicle system, or the like, and is received by a gateway control system or transactional system.

The term “user identifier” includes a unique user identifier such as a username, account number, or the like.

The term “registered user” refers to a user that is recognized as a registered user by at least a transactional system. A “registered user” can optionally include a dual-registered user. A registered user may be associated with a user identifier. In some embodiments, a registered user may have a user profile saved to the transactional system comprising one or more datum about the user.

The term “dual-registered user” refers to a registered user that is recognized as a registered user by at least a transactional system and a vehicle system. The dual-registered user is associated with a driver, a vehicle, and a registered user of the transactional system. A dual-registered user may have a single user identifier associated with multiple systems and/or may have separate identifiers associated with each system.

The term “subject user identifier” includes an indication of a registered user for which authentication is requested. The term “subject identity” refers to a physical being associated with the subject user identifier (and a particular registered user or dual-registered user).

The term “current driver identity” refers to an indication of physical being associated with a vehicle, such as a user using a user device, a mobile device, or a vehicle-based user device. The current driver identity may be determined in response to a subject user identifier. In some embodiments, a subject user identifier may be transmitted to an authentication system and a current driver identity may represent a confirmation that the subject user identity has been verified or determined (e.g., above a confidence threshold). The current driver identity may refer to an indication of a physical being for which secure authentication is requested. In some embodiments, a current driver identity may be determined by an authentication system independently of a request and/or without an initial subject user identifier to verify.

The term “transactional system” refers to one or more computing entities such as a server, computer, distributed system, a portion of any of the foregoing, or the like, including hardware and software. The transactional system can include a dispensing control system, a payment server, and other transaction related subsystems. The transactional system is at least partially implemented at the establishment (e.g., bank, restaurant, store, etc.). Some aspects may be implemented remotely and/or locally. In some embodiments, at least a portion of a transactional system may be embodied in association with a vehicle (e.g., an app operating on a vehicle computing device (e.g., a vehicle infotainment system) and/or user mobile device). In some non-limiting examples, the transactional system may be affiliated with a lender, credit card company, investment institution, or the like, such as one that issues credit cards to cardholders, and facilitates authorization, settlement and funding.

The term “dispensing control system” refers to one or more computing entities such as a server, computer, distributed system, or the like, including hardware and software. The dispensing control system may securely control physical or mechanical operation of one or more dispensing devices located onsite at an establishment associated with the transactional system and dispensing control system.

The term “dispensing device” refers a physical device located at the establishment affiliated with the transactional system. The dispensing device includes at least a mechanical or physical component that enables secure dispensing of or access to products, currency or any other transaction output, to a user. For example, the one or more dispensing devices may include an automated teller machine (ATM), one or more secure lockers, one or more pneumatic tube devices, and/or the like. The dispensing device can be controlled by at least hardware or software. The dispensing device can include a locker that enables secure access by employees of the establishment and by certain users.

The term “payment server” refers to one or more computing entities such as a server, computer, distributed system, or the like, including hardware and software. The payment server is a part of or associated with the transactional system associated with an establishment and is implemented on-premises at an establishment that collects payment for goods or services. The payment server collects payment and communicates with other aspects of the transactional system, some of which can be remote from the establishment, to receive payment statuses such as confirmed or declined.

The term “vehicle-transmitted transaction data object” refers to a transaction data object that is generated and/or modified by a vehicle system and transmitted from a vehicle system, such as from a vehicle transceiver. A vehicle-transmitted transaction data object can be transmitted via a communication protocol such as a wireless short-range communication protocol that utilizes a low energy and high bandwidth, such as UWB communication protocol.

The term “on-premises transaction data object” refers to a transaction data object that is generated by a terminal based on data received via the on-premises transceiver, such as implemented at or outside an establishment. An on-premises transaction data object can be transmitted via a communication protocol such as a LoRa protocol derived from chirp spread spectrum (CSS) technology over a long-range wide area network (LoRaWAN).

The term “vehicle system” refers to hardware and software components of or associated with a vehicle. In some embodiments, a vehicle system may include functionality provided by a user mobile device or other device in or on the vehicle, which may be in direct or indirect communication with other processing devices of the vehicle (e.g., a vehicle ECU, one or more sensors, etc.).

The term “electronic control unit” or “ECU” refers to hardware and software components that control various components of a vehicle.

The term “vehicle sensor” refers to any sensor configured in or on a vehicle, or otherwise configured to measure vehicle-related data, and configured to collect data pertaining to the operation of the vehicle and functioning of vehicle components.

The term “vehicle sensor data object” refers to electronic data derived from or generated from one or more vehicle sensors configured to sense or collect data pertaining to the operation of the vehicle and functioning of vehicle components. In some embodiments, vehicle sensor data objects may be received, stored, and/or accessed in one or more remote locations (e.g., a vehicle manufacturer server via an API), such that the vehicle may transmit data to the remote location for subsequent access by a third party (e.g., a transactional system). The term “current vehicle sensor data objects” refers to one or more vehicle sensor data objects associated with a current vehicle usage or current driving session, including but not limited to real time or near real time vehicle data.

The term “vehicle-based user device” refers to a user device (e.g., a user mobile device) affixed to one or more components of a vehicle, and may include an infotainment system, dashboard mounted display, integrated user interface, or the like.

The term “vehicle transceiver” refers to hardware such as a transmitter, a receiver, antenna, and supporting circuitry, and is configured on or in a vehicle. A vehicle transceiver may be configured to transmit vehicle sensor data and/or receive one or more data objects transmitted by other systems or apparatuses.

The term “driver authentication apparatus” refers to one or more computing entities such as a server, computer, distributed system, or the like, including hardware and software configured to use a driver authentication model to generate authentication scores.

The term “driver authentication model” refers to a machine learning model, including data representations of nodes (e.g., neural network nodes, decision tree nodes, Markov model nodes, other nodes, or combinations thereof) and connections between nodes (e.g., weighted or unweighted unidirectional or bidirectional connections). In certain embodiments, the driver authentication model includes a representation of memory (e.g., providing long short-term memory functionality). The driver authentication model is configured to generate driver authentication scores or otherwise facilitate identification or verification of a driver of a vehicle. In an example, an identity profile can be matched as a customer through a feed forward neural network, but other techniques can be used, including state machines and a set of business rules (e.g., if weight is more than a threshold distance away from a starting weight, then the match for a specific customer is false) for each parameter.

The term “gateway control system” refers to one or more computing entities such as a server, computer, distributed system, or the like, including hardware and software, configured to receive authentication request data objects, authenticate the user, establish a secure communication session between devices, and enable or facilitate a transaction via a transactional system. In some embodiments, a gateway control system may be part of a transactional system or controls access to a transactional system.

The term “authentication request data object” refers to electronic data representing a request to authenticate a driver. An authentication request data object can include one or more subject user identifiers for which authentication is requested. In some embodiments, the authentication request data object may be associated with a predetermined vehicle or vehicles. The authentication request data object may include vehicle identifiers configured to cause the authentication system to determine (e.g., identify or verify) the identity of a current driver of a particular vehicle. For example, an authentication request data object may include an indicia configured to cause the authentication system to retrieve current vehicle sensor data from one or more vehicles and output a score or other output indicative of the driver of at least one of the one or more vehicles.

The term “authentication score” refers to electronic data that can be transmitted between computing devices and is indicative of a likelihood that a current driver identity associated with one or more current vehicle sensor data objects matches one or more subject identities.

The term “vehicle-directed confirmation data object” refers to electronic data that can be transmitted to a vehicle system and provided via a user interface. A vehicle-directed confirmation data object may be indicative of a successful transaction or other transaction related confirmation data and can optionally include an instruction data object.

The term “instruction data object” refers to electronic data that can be transmitted between computing devices and provided via a user interface to enable or to assist a user in obtaining transaction outputs (e.g., currency, goods, etc.) at an establishment. The instruction data object can include instructions regarding a lane, kiosk, locker, parking space, locker code, quick response (QR) code. The instruction data object may comprise one or more renderable data objects or computer executable instructions configured to render one or more data representations (e.g., images, text, etc.) on a display.

The term “vehicle detection system” refers to any hardware and software configured to detect a physical presence of a vehicle in a location associated with an establishment, such as a parking area or pickup area of an establishment. The vehicle detection system can further include sensors, transceivers, and the like and can be implemented as a geo-fence. In some embodiments, a vehicle detection system may include one or more terminals, as described herein.

The term “detected vehicle data object” refers to electronic data generated by a vehicle detection system and indicating a vehicle detected on the premises of an establishment. A detected vehicle data object can include any signal indicative of a presence of a vehicle and can further trigger, directly or indirectly, generation or transmission of an authentication request data object to an external device.

The term “location data” refers to electronic data indicating or describing a physical location of a user device or vehicle. The location data can include or can be generated from a global positioning system (GPS). In some embodiments, the location data may be generated based on signals from a transceiver mounted on or in a vehicle (e.g., a vehicle GPS transceiver, a user mobile device GPS transceiver, a vehicle or user mobile device cellular transceiver, etc.). In some embodiments, the location data may be generated based on signals received from a remote device (e.g., a triangulation of a vehicle location using cellular tower data or other location detection techniques).

The term “proximity-based terminal” refers to hardware and software components configured to directly and, in some embodiments, wirelessly interact with a vehicle system to facilitate a transaction. The proximity-based terminal may include a physical device mounted at a physical location of an establishment. In some embodiments, the proximity-based terminal may be configured to wiredly and/or wirelessly interact with at least one portion of a transactional system, including one or more local computing device(s) at the physical location of the establishment. The proximity-based terminal may be configured to convert data received by an on-premises transceiver and transmit data, directly or indirectly, to a payment server. The proximity-based terminal may be configured to receive and transmit data using multiple wireless protocols, including but not limited to UWB and LoRa. In some embodiments, the terminal may be solar and/or battery powered. The terminal may be installed at an establishment adjacent to a particular vehicle interaction location (e.g., a parking spot), and the terminal may (e.g., via UWB) facilitate detection of, identification of, and communication with a vehicle in the vehicle interaction location.

The term “on-premises transceiver” refers to hardware such as a transmitter, a receiver, antenna, and supporting circuitry, and is configured on the premises of an establishment. An on-premises transceiver can include an UWB transceiver configured for UWB communication, a LoRa transceiver configured for LoRa communication, and the like.

The term “vehicle position data object” refers to a type of location data indicative of a position of a vehicle on a premises of an establishment. A vehicle position data object includes more specific position data than what may be included in a detected vehicle data object. A vehicle position data object can include a level of detail indicative of coordinates, a parking spot, a lane, or other position data. The vehicle position data object may be generated by a transceiver, such as but not limited to a vehicle transceiver and an on-premises transceiver. Data communicated via an UWB communication protocol can be used to generate the vehicle position data object.

The term “secure communication session”, “secure communication”, “secure connection”, “secure session”, and the like refer interchangeably to a temporary exchange of information between two or more devices with reliability, confidentiality, integrity and authenticity. When two devices are connected via a secure communication session, a user can use one device to access secure information from a second device, such as a transactional system. A secure communication session can facilitate occurrence of a transaction, including one or more sub-steps of a transaction.

The term “label” refers to known and true data associated with a user entity and used to train the driver authentical model. A label can include an identifier of a registered user, and vehicle sensor data objects.

### Example System Architecture

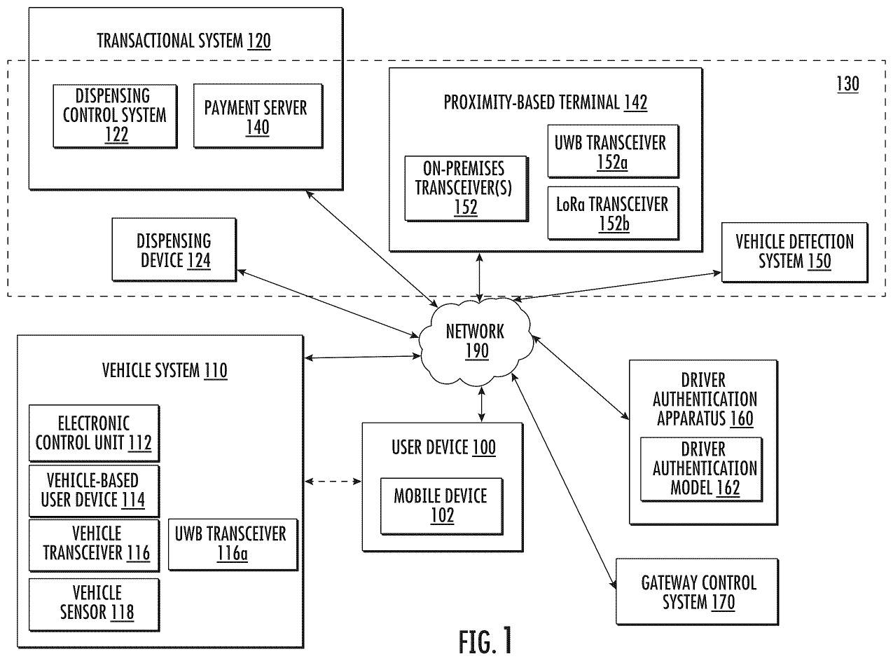

Methods, apparatuses, and computer program products of the present disclosure may be embodied by any of a variety of devices and systems. For example, the method, apparatus, and computer program product of an example embodiment may be embodied by a networked device, such as a server or other network entity, configured to communicate with one or more devices, such as those depicted in FIG. 1. Additionally or alternatively, the system may include fixed computing devices, such as a personal computer or a computer workstation. Still further, example embodiments may be embodied by any of a variety of mobile devices, personal computer, laptop computer, tablet, onboard computing devices (e.g., vehicle computing devices), various other fixed or mobile devices, or the like. An example system that can be used according to examples herein is described in FIG. 1, depicting various devices and components connected to at least one network 190.

The user device 100 is a device used by a user that can be used as part of processes described herein. In many examples, the user device 100 is a personal computing device, such as a desktop computer or, as illustrated in FIG. 1, a mobile device 102 such as a smart phone, smart watch, tablet, or laptop computer. A user may use multiple user devices 100, which may include a mobile device 102 and/or one or more other devices (e.g., personal computers) to interact with a transactional system 120, either directly or indirectly, such as to initiate certain transactions or orders, such as bank account withdrawals, grocery orders, and/or the like. The user device 100 (e.g., a mobile device 102) may be designed to be freely and frequently moved by or with a user, such as in a pocket, in a purse, worn by the user, or the like. According to certain embodiments, the mobile device 102 may communicate with another user device 100 and/or vehicle system 110, such as via a near field communication protocol, including BLUETOOTH communication protocol or the like. In some embodiments, the mobile device 102 and/or another user device 100 may communicate with a vehicle system 110 over a wide area network (e.g., a cellular or Wi-Fi network).

The vehicle system 110 may include any hardware and software components of or associated with a vehicle. The vehicle may be anything that is used to transport a user and/or goods, such as a car, a motorcycle, a delivery truck, or the like. The vehicle system 110 may include an ECU 112 that may generate or obtain at least some vehicle sensor data objects and, in some embodiments, interacts with and controls various subsystems, sensors, and other components of the vehicle system 110. In some embodiments, the ECU may include or be connected to separate or aftermarket computing devices coupled to a vehicle electronics system.

The vehicle system 110 may include a vehicle-based user device 114 that includes a user interface and that communicates with the ECU 112. The vehicle-based user device 114 may include an infotainment system, a touch screen, user interface display, other user interface components such as knobs, buttons and controllers, microphones, speakers, and the like to enable a user to interact with certain systems include subsystems of the vehicle system 110. A vehicle-based user device 114 is affixed to physical components of the vehicle, and although it can be installed, replaced, or upgraded, is generally not moved to and from the vehicle as freely or as frequently as a mobile device 102 such as a smart phone, wearable device, or the like. A user may use a vehicle-based user device 114 of the vehicle system 110 to interact with a transactional system 120 directly and indirectly, regarding certain transactions or orders, such as bank account withdrawals, grocery orders, and/or the like.

In some embodiments, the vehicle-based user device 114 may electronically communicate a user device 100 (e.g., directly or over a wider network) to facilitate functionalities of the user device and/or the vehicle-based user device. For example, a user device 100 may communicate with a transactional system 120 (e.g., via network 190) and a vehicle-based user device 114 may operate as an intermediary for video signals from the user device to be displayed to a user via a display of the vehicle-based user device and/or inputs to the vehicle-based user device 114 (e.g., via a touchscreen) to be passed back to the user device (e.g., x-y coordinates transmitted back to the user device 100 for correlating to on-screen commands). In some embodiments, the user device 100 may be mounted in or on a vehicle and a user may directly control the user device 100 from the vehicle to perform at least some functions associated with either the vehicle-based user device 114 or the user device.

The vehicle system 110 may include a vehicle transceiver receiver 116, such as but not limited to UWB transceiver 116a. The vehicle system 110 may include a variety of sensors 118, such as but not limited to one or more weight sensors configured to sense a weight of a driver or a passenger in the vehicle. The vehicle sensors 118 may include sensors for collecting data pertaining to the operation of the vehicle and functioning of vehicle components. The vehicle sensors 118 may include original sensors installed during vehicle assembly (e.g., certain seat-mounted weight sensors, GPS receivers, etc.) and/or aftermarket sensors or separate sensors mounted on or in the vehicle. The vehicle sensor(s) 118 may include sensors mounted in or adjacent to the interior cabin of the vehicle and configured to detect one or more directly detectable attributes of the driver or another occupant of the vehicle, such as a steering wheel touch sensor, a seat-based weight sensor, a driver monitoring camera, or the like. In some embodiments, the vehicle sensor(s) 118 may include sensors configured to measure inputs to or performance of the vehicle, such as forward, rearward, and/or lateral acceleration data, position data, etc. For example, and not by way of limitation, the vehicle sensors 118 can collect data pertaining to a driver's weight, speed data, acceleration data, temperature data, precipitation data, pressure data, proximity data, visual characteristics, audio characteristics, other data, or combinations thereof. The vehicle sensors 118 can include a global positioning system or other positioning system. The vehicle sensors 118 can include bio-readers, such as but not limited to a retina scanner, a breathalyzer, a fingerprint scanner, and the like. In examples, data regarding vehicle profile parameters can be used, such as memory positions for seats, mirrors, or radio presets. These are items that can be linked to specific car keys or key fobs or memory buttons within the vehicle. In some examples, data from the vehicle sensors 118 can be supplemented with (or replaced by) data from non-vehicle sensors. For instance, one or more user devices (e.g., mobile phones, smart watches, virtual reality headsets, headphones, implanted or wearable medical devices, other devices, or combinations thereof) may be located proximate the car (e.g., within a cabin of the car) and include sensors (e.g., location sensors, microphones, cameras, gyroscopes, accelerometers, other sensors, or combinations thereof) that can produce data that can be used with techniques described herein.

The vehicle system 110, such as with an ECU 112, can at least partially control data collection from various components of the vehicle system 110, and communicate the data, such as via the vehicle transceiver 116 to other components of the system of FIG. 1. In some embodiments, a user device 100 or another device may at least partially control data collection from the vehicle environment and/or vehicle occupant(s).

The transactional system 120 may be affiliated with or operated by a physical establishment which a vehicle and driver may visit to conduct or complete a transaction. The transactional system 120 may, as non-limiting contextual examples, at least partially control transactions performed at a bank branch, a restaurant, a grocery store, or the like. In some embodiments, the transactional system 120 can be affiliated with a lender, credit card company, investment institution, or the like, such as one that issues credit cards to cardholders, and facilitates authorization, settlement and funding. According to certain embodiments, some aspects of the transactional system 120 may be implemented on-premises at an establishment, but it will be appreciated that certain aspects may be implemented at a server or system remote from the on-site establishment. Other than portions required, either expressly or by their nature, to be performed at a particular location, various other portions of the transactional system may be implemented in any location. An example embodiment of systems and components that can be physically implemented or present at an establishment in some example embodiments are encompassed by the dashed line 130. It will be appreciated that certain aspects of transactional system 120 (or other components of the system of FIG. 1) may be partially implemented on-site and partially off-site such as remotely. Certain systems (e.g., a driver authentication apparatus 160, gateway control system 170, etc.) may be implemented in any location, including at least partly on-premises at an establishment or in a vehicle. For example, a local bank branch that operates in association with a financial institution may implement certain functionality of the transactional system 120 on remote systems, distributed systems, or the like. Similar distribution of components or systems of the system of FIG. 1 may be contemplated.

The system of FIG. 1 can include a dispensing control system 122, which may include one or more dispensing devices 124. According to certain embodiments, the transactional system 120 includes or communicates with the dispensing control system 122 that securely controls physical or mechanical operation of one or more dispensing devices 124 located onsite at the establishment. In some embodiments, the dispensing control system may be embodied as a single device including the dispensing device hardware and control system. In some embodiments, the dispensing control system may include a centralized or remote system configured to control multiple dispensing control devices, which devices may include individual hardware and software for executing dispensing of transaction outputs. In some embodiments, a dispensing device 124 or other apparatus of a dispensing system 122 may establish a direct, point-to-point wireless connection with a vehicle system 110 and/or user device 100 to facilitate the various functions described herein, including but not limited to establishing secure sessions, location detection, payment information transmission, or other data exchange. In some embodiments, a dispensing device 124 or other apparatus of a dispensing system 122 may establish an indirect connection with a vehicle system 110 and/or user device 100 (e.g., over one or more intermediate notes, including but not limited to using the Internet) to facilitate the various functions described herein.

A dispensing device 124 includes a physical device located at the establishment affiliated with the transactional system 120. For example, the one or more dispensing devices 124 may include an automated teller machine (ATM), one or more secure lockers, one or more pneumatic tube devices, and/or the like. The dispensing devices 124 may be controlled at least partially by the transactional system 120, such as with the dispensing control system 122 to operate at least a mechanical or physical component of the dispensing device 124 to securely dispense or securely enable access to one or more products, currency, and/or the like. For example, the dispensing control system 122 controls the dispense of cash at a dispensing device 124 implemented as an ATM. The dispensing device 124 may include a locker with a secure door that can be securely opened for access by the transactional system 120, to enable a user to obtain checks, coins, groceries, deliveries, or the like. The dispensing device 124 may include a pneumatic tube system that is securely activated to dispense cash, checks, coins, or the like via a pneumatic tube and container accessible by a user and controlled at least partially by the dispensing control system 122. The dispensing device 124, in some embodiments, may interact with an establishment operator (e.g., a teller loading a pneumatic tube) and/or in some embodiments may be partly or fully autonomous. In non-fully autonomous embodiments, the dispensing control system 122 may include a kiosk or other user device may deliver instructions to the establishment operator. The dispensing control system 122 may therefore include hardware, software, or a combination thereof configured to control the dispensing device 124. According to certain embodiments, the dispensing control system 122 is embodied in or partially embodied in a structure of the dispensing device 124. According to certain embodiments, such as when a transaction comprises a payment, but goods are delivered by other means, such as by waitstaff, the dispensing control system 122 and the dispensing device 124 may be optional or omitted from the system of FIG. 1.

According to certain embodiments, the transactional system 120 optionally includes or communicates with a payment server 140 that initiates or otherwise processes payments directly or indirectly (e.g., via a payment processing system) in addition to or instead of the dispensing control system 122. Accordingly, the dispensing device 124 and dispensing control system 122 is not present according to certain example embodiments. The payment server 140 can be configured to accept payment data from one or more point-of-sale devices such as those configured in a restaurant or store and transmits the payment data to a payment processing system to facilitate verification and settlement. In some embodiments, the payment server 140 may remotely receive payment data (e.g., via network-based payment) without requiring a physical point-of-sale payment processing device on-premises at the establishment. In some embodiments, the payment server 140 may receive a confirmation of successful payment, such that the dispensing control system 122 may then control the dispensing of goods, currency, or the like via the dispensing device 124 or the transactional system may otherwise facilitate execution of the transaction. In some embodiments, after receiving a confirmation of successful payment via the payment server 140, the transactional system 120 may provide communication to an establishment operator (e.g., employee) to deliver food, groceries, or other goods to a vehicle.

The vehicle detection system 150 includes one or more devices, sensors, or the like configured to detect a physical presence of a vehicle at a particular location such as a parking area or pickup area of an establishment, such as a retail banking location, restaurant, or the like. The vehicle detection system 150 may include weight sensors configured to detect an arrived or arriving vehicle on the weight sensor. The vehicle detection system 150 can include one or more motion sensors configured to detect a vehicle. The vehicle detection system 150 can include one or more camera sensors configured to read a vehicle identification number (VIN), a license plate, or other vehicle identifying information. The vehicle detection system 150 can include a network-enabled geo-fence, one or more transceivers configured for short-range communication or near field communication, or the like.

According to certain embodiments, although not illustrated as such in FIG. 1, the vehicle detection system 150 can include a proximity-based terminal 142, which may include one or more n on-premises transceivers 152. An on-premises transceiver can include a UWB transceiver 152a and a LoRa transceiver 152b.

The UWB transceiver 152a and can be configured to detect a presence of a vehicle, such as via short-range wireless radio that may facilitate determining the position of the vehicle. In some embodiments, only one vehicle or a small number of vehicles may be within range of an a UWB transceiver 152a at a time which may allow the transactional system 120 to infer the location of the vehicle based on the terminal(s) to which a vehicle is connected.

In some example embodiments, the on-premises transceiver 152 can be embodied in a proximity-based terminal 142 that is positioned on-premises at an establishment outside a physical building of the establishment (e.g., adjacent to or within a parking lot of an establishment. The on-premises transceiver 152 communicates with the vehicle transceiver 116 such as UWB transceiver 116a or a corresponding transceiver of a user device 100, and in some embodiments, the on-premises transceiver 152 and vehicle transceiver 116 and/or user device 100 may communicate via direct, point-to-point communication protocol. The on-premises transceiver 152 can communicate with the vehicle transceiver 116 and/or user device 100 using a first wireless communication protocol, such as a short-range communication protocol that uses low energy in comparison to many communication protocols. For example, in some embodiments, the on-premises transceiver 152 communicates with the vehicle transceiver 116 such as UWB transceiver 116a using UWB communication and due to low energy requirements be powered by a solar-charged battery, 9-volt battery or the like, although any type of power source can be contemplated. The on-premises transceiver 152 can use a communication protocol such as UWB communication, to benefit from its precise and efficient position detection capabilities. For example, using UWB communication, the proximity-based terminal 142 of the vehicle system 110 can determine a vehicle position, including which of several parking spaces or lanes in which a vehicle is located. According to certain embodiments, the proximity-based terminal 142 comprises a dispensing device 124, or vice versa. In some embodiments, the vehicle system 110 may act as a transaction execution device for the transaction via direct, secure communication with the terminal 142 (e.g., with the vehicle system 110 serving as a credit card or other electronic payment device, such that no other devices are needed to execute the transaction). In some further embodiments, the user device 100 and/or the vehicle-based user device 114 may initiate the transaction (e.g., via electronic order) and the vehicle system 110 may then execute the transaction as the transaction execution device.

The UWB communication protocol uses data packets configured in a specific format. The format can vary depending on the specific UWB standard or implementation. The format can include a preamble, start frame delimiter (SFD), a header, a data payload, and a frame check sequence.

According to certain embodiments, the on-premises transceiver 152 can provide communication functionality not necessarily associated with a vehicle detection system 150. In this regard, the on-premises transceiver 152 may receive payment data and other customer data from the vehicle system 110, enabling the proximity-based terminal 142 to communicate it to the transactional system 120 or other components of FIG. 1 to execute the transaction with the received data.

The proximity-based terminal 142 includes hardware and software components configured to convert data received at a UWB transceiver 152a and transmit the data, via LoRa transceiver 152b, also referred to as a LoRa network end node to a payment server 140 for further processing. In this regard, the proximity-based terminal 142 can leverage the payment server 140 that can also be utilized for in-store point-of-sale transactions to initiate payments from the vehicle system 110. The proximity-based terminal 142, such as with LoRa transceiver 152b transmits data via a long-range communication protocol that is different than the first wireless communication protocol. For example, proximity-based terminal 142 may communicate via a wireless protocol such as LoRa protocol, or another communication protocol that can be based on wireless or wired communication.

In some such embodiments, the LoRa protocol may ensure efficient and reliable data transmission. The LoRa protocol can be used over longer distances in comparison to UWB but can also function with lower power consumption. A data packet formatted according to the LoRa includes a preamble, header, and payload.

The driver authentication apparatus 160 is configured to generate, store, and train a driver authentication model 162 based on data received from the one or more vehicle systems 110. One or more driver profiles may be stored in association with a particular vehicle system 110 instance. The driver authentication apparatus 160 may further include a driver authentication model 162 which may be trained to generate an authentication score indicating whether a subject driver matches a particular driver associated with stored driver profile data. The driver authentication apparatus 160 may be in electronic communication with a vehicle system 110 to send and transmit requests and instructions and to receive vehicle sensor data, whether raw or partly or fully pre-processed by the vehicle system 110 for use with generating and executing the driver authentication model 162. According to certain embodiments, the functionality of the driver authentication apparatus 160 and the driver authentication model 162 can be implemented at the vehicle system 110 and/or the transactional system 120.

The gateway control system 170 communicates with the driver authentication apparatus 160 to determine whether a particular user or driver is authorized to interact with the transactional system 120 via a secure communication session, such as using the vehicle-based user device 114 and user device 100. According to certain embodiments, although not depicted as such in FIG. 1, the driver authentication model 162 can be implemented within the vehicle system 110. In such examples, the authentication score is generated at the vehicle system 110 prior to performing a subsequent action, such as communication of certain data from the vehicle system 110.

The gateway control system 170 may include one or more servers, a distributed system, or the like, configured to facilitate a secure transaction while a user interacts with a vehicle-based user device 114, and enables the user to be authenticated and to obtain a transaction output (e.g., currency or other product) from a dispensing device 124 or otherwise take a preconfigured action or carry out a transaction. Additionally or alternatively, the gateway control system 170 is configured to facilitate payment on behalf of a driver of the vehicle system 110. The gateway control system 170 facilitates such methods by communicating directly or indirectly with any of the user device 100, vehicle system 110, driver authentication apparatus 160, transactional system 120, dispensing device 124 and the vehicle detection system 150. According to certain embodiments, the gateway control system 170 includes the driver authentication apparatus 160.

The network 190 may include one or more devices or portions of devices that facilitate communication from a sender to a destination, such as by implementing communication protocols. Example networks 190 include local area networks, wide area networks, private networks such as an intranet, public networks such as the Internet, or any combination thereof. Although depicted as a single network 190 in FIG. 1, the network may comprise a plurality of different networks using different hardware and/or different protocols. The network 190 may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network 190 may include a cellular network, an 802.11, 802.16, 802.20, or WiMax network. The network 190 may utilize a variety of networking protocols now available or later developed including, but not limited to Transmission Control Protocol, Internet Protocol, etc. According to certain embodiments disclosed herein, certain communication protocols may be advantageously utilized for network communication between certain system components depicted in FIG. 1. For example, in certain embodiments, the vehicle system 110, such as by the vehicle-based user device 114, may communicate with the on-premises transceiver 152 via UWB communication, and the gateway control system 170 may communicate with the transactional system 120 via LoRa communication. Accordingly, the network 190 can include a UWB network and a LoRa network. Although embodiments of the vehicle transceiver 116 may be configured on or within the vehicle, the vehicle transceiver 116 may be considered a component of network 190. Similarly, the on-premises transceiver 152 depicted as a part of the vehicle detection system 150 may be considered a component of network 190. The network 190 may be further configured to facilitate near field communication, such as BLUETOOTH communication, between components, such as but not limited to the mobile device 102 and vehicle system 110.

It will be appreciated that according to certain embodiments, certain components of FIG. 1 can be implemented as or within another component of FIG. 1. For example, a gateway control system 170 can be implemented as or within a transactional system 120. A driver authentication apparatus 160 can be implemented as or within a vehicle system 110, transactional system 120, or the like. A dispensing device 124 and proximity-based terminal 142 may be implemented within a common apparatus. A vehicle detection system 150 can be implemented in the proximity-based terminal 142 or dispensing device 124. Numerous variations can be contemplated.

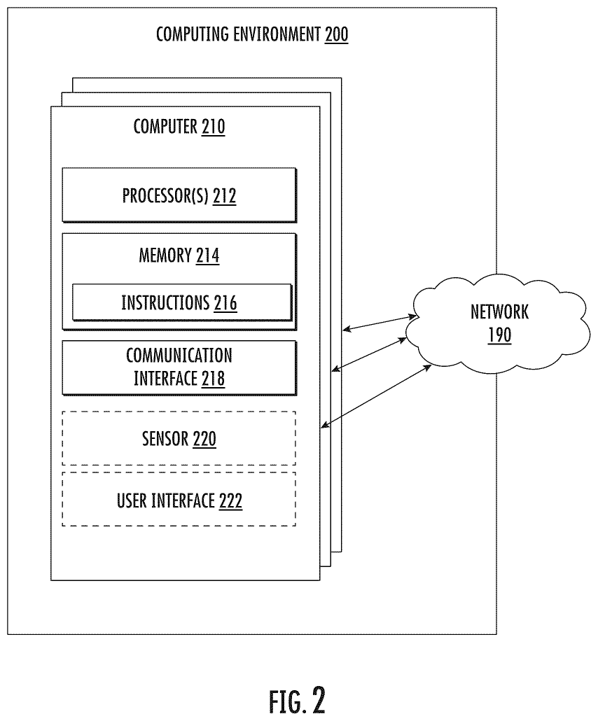

The components of FIG. 1 can include one or more aspects described elsewhere herein such as in reference to the computing environment 200 of FIG. 2.

### Example Computing Environment

FIG. 2 discloses a computing environment 200 in which aspects of the present disclosure may be implemented. The computing environment of FIG. 2 may implement certain components depicted in FIG. 1 and can be utilized herein according to certain embodiments.

A computing environment 200 is a set of one or more virtual or physical computers 210 that individually or in cooperation achieve tasks, such as implementing one or more aspects described herein. The computers 210 have components that cooperate to cause output based on input. Example computers 210 may include desktops, servers, mobile devices (e.g., smart phones and laptops), vehicle ECUs or other vehicle-based devices, on-premises devices, terminals, wearables, virtual reality devices, augmented reality devices, expanded reality devices, spatial computing devices, virtualized devices, other computers, or combinations thereof. In particular example implementations, the computing environment 200 includes at least one physical computer.

The computing environment 200 may specifically be used to implement one or more aspects described herein, including but not limited to defining one or more of the user device 100, the vehicle system 110, the transactional system 120, the driver authentication apparatus 160, the gateway control system 170, the dispensing device 124, the proximity-based terminal 142, and/or the vehicle detection system 150. In some examples, one or more of the computers 210 may be used to implement aspects of a machine learning framework useable to train and deploy models exposed to the mobile device or provide other functionality, such as through exposed application programming interfaces.

The computing environment 200 can be arranged in any of a variety of ways. The computers 210 can be local to or remote from other computers 210 of the environment 200. The computing environment 200 can include computers 210 arranged according to client-server models, peer-to-peer models, edge computing models, other models, or combinations thereof.

In many examples, the computers 210 are communicatively coupled with devices internal or external to the computing environment 200 via network 190. The network 190 is a set of devices that facilitate communication from a sender to a destination, such as by implementing communication protocols. Example networks 190 include local area networks, wide area networks, intranets, or the Internet.

In some implementations, computers 210 can be general-purpose computing devices (e.g., consumer computing devices). In some instances, via hardware or software configuration, computers 210 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 210 include one or more processors 212, memory 214, communication interfaces 218, sensors 220, and user interfaces 222. Such components can be virtual, physical, or combinations thereof.

The one or more processors 212 are components that execute instructions, such as instructions that obtain data, process the data, and provide output based on the processing. The one or more processors 212 often obtain instructions and data stored in the memory 214. The one or more processors 212 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 212 include at least one physical processor implemented as an electrical circuit. Example providers of processors 212 include INTEL, AMD, QUALCOMM, TEXAS INSTRUMENTS, and APPLE.

The memory 214 is a collection of components configured to store instructions 216 and data for later retrieval and use. The instructions 216 can, when executed by the one or more processors 212, cause execution of one or more operations that implement aspects described herein. In many examples, the memory 214 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, transitory memory 214 can store information encoded in transient signals.

The one or more communication interfaces 218 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, UWB, LoRa or other protocols). One or more of the one or more communication interfaces 218 can facilitate connection of the computing environment 200 to a network 190.

As shown by the dashed lines in FIG. 2, the one or more sensors 220 and user interfaces 222 may be optional in some instances of computing environment 200. For example, the driver authentication apparatus 160 may not necessarily include a sensor or a user interface.

The one or more user interfaces 222 are components that facilitate receiving input from and providing output to a user, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons).

The computers 210 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Example System Operation and Related Methods

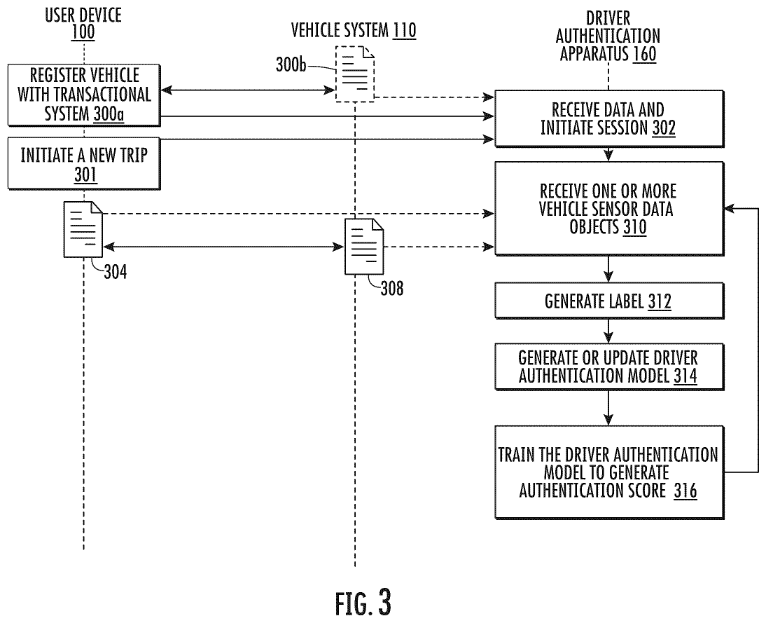

FIG. 3 is a sequence diagram illustrating a process according to example embodiments, relating to registering a vehicle, generating a driver authentication model 162, and training the model to generate authentication scores.

At operation 300a, a user registered with a transactional system 120 accesses a secure session facilitated via a mobile app or website such as operated by the transactional system 120 and registers their vehicle with the transactional system 120. The registration can occur in a variety of ways. If located in the vehicle, the user device 100 (mobile device 102) may connect with the vehicle system 110 using near field communication such as BLUETOOTH communication or wired communication. According to certain embodiments, a software and/or hardware interface that facilitates communication between a mobile device 102 and vehicle system 110 can be used to implement certain features disclosed herein. For example, APPLE CARPLAY or ANDROID AUTO can be used to facilitate communications between a mobile device 102 and a vehicle system 110 and subsequently with various external systems, but other methods can be contemplated.

In some embodiments, after connection between the user device 100 (e.g., a mobile device 102) and the vehicle system 110 is established, the user device 100 may facilitate the initial registration with the transactional system 120. For example, an app affiliated with the transactional system 120 and operative on the mobile device 102 can monitor for connections between the mobile device 102 and external vehicle systems, and the app and/or a corresponding vehicle-based user device 114 of the vehicle may notify the user or prompt the user to set up the vehicle. In some embodiments, a user's mobile device may include a first app associated with the transactional system 120 and a second app associated with the vehicle (e.g., an original equipment manufacturer (OEM) vehicle app), and the first app may detect the presence or operation of the second app to trigger a registration process. In some examples, a vehicle can be registered without establishing a direct connection between the mobile device and the vehicle. For instance, sufficient information may be available through an OEM or simply by entering or obtaining the license plate or VIN. Such information can be used to create a limited identity profile that could be used to reduce an amount of authentication that is required. For instance, a drive-up ATM scans a license plate of a vehicle and requires only a first level of authentication (e.g., merely requires a user to enter their PIN) rather than a second, higher level of authentication (e.g., requiring both an ATM card swipe and entry of the PIN).

The user can then follow steps on the user device 100 and vehicle-based user device 114 to complete the registration of the vehicle. The registration process may comprise inputting information into the transactional system 120. For example, the user can add payment or other details for accounts such as credit cards that may be used for vehicle-based payments. For example, the user can input and/or confirm their bank details and select with which accounts the user would like to be able to perform transactions (e.g., ATM withdrawals or the like). In some embodiments, the registration process allows the user to link any third-party services that may connect with and use the vehicle-based authentication. In some embodiments, the user may provide vehicle-identifying information such as a license plate, VIN number, make, model, color, or the like. The vehicle-identifying information, as discussed below, may be used as part of an on-premises vehicle detection system 150. For example, the user can photograph the license plate, VIN number, or any other visible details about the vehicle and upload the photo, and/or the user can type. The user provides authorization to conduct transactions from their vehicle. An identifier associated with a registered user can be stored at the transactional system and vehicle system that uniquely identifies the user in association with an account with the transactional system. In some embodiments, vehicle-based authentication may be a sub-feature of a transactional system mobile app or other software application, such that the application is configured to execute transactions or perform other functions with or without vehicle-based authentication enabled.

In some embodiments, the vehicle system 110 may transmit data to the user device 100 and/or the driver authentication apparatus 160 during the initial registration process. For example, at step 300b, the vehicle ECU 112 may generate at least a portion of the registration data discussed herein (e.g., make, model, etc.), which may be transmitted to the driver authentication apparatus directly or via the user device 100. A user may be prompted (e.g., via a user device or vehicle-based user device) to confirm data gathered from the vehicle, and the user may be further prompted to add the photos or other information not stored by the vehicle system.

At operation 302, the driver authentication apparatus 160 may receive the registration data, either as a single transmission or multiple transmissions from the user device 100 and/or vehicle system 110. For example, the driver authentication apparatus 160 may receive the first identifier associated with a registered user, which may be associated with the driver of the vehicle. For example, the user may be registered with the transactional system 120 prior to or while initiating registration of the vehicle, and during the registration process, the transactional system 120 may also store an association (e.g., a flag or other data value in memory) identifying the registered user as a driver of the vehicle. The registered user's identity as the driver may be used to label the vehicle sensor data objects for future model generation. In some embodiments, the registered user's identity may be initially determined via authentication with the transactional system 120 (e.g., entry of the user's login credentials, bank information, account number, or the like). The registered user may be a dual-registered user as defined herein. Registration with both a vehicle system account and a transactional system account may facilitate linking the two accounts for expedited registration. The driver authentication apparatus 160 starts building a driver profile as set forth below. Multiple identifiers of dual-registered users can be associated with a vehicle, and each can have separate relationships or accounts with an institution affiliated with a transactional system.

Upon initial registration and over the course of time as the driver drives the vehicle (e.g., over one or more trips), the driver can carry a user device 100 such as a mobile device 102. The mobile device 102 generates data 304, such as indicators of an identifier associated with a registered user. The vehicle system 110 collects vehicle sensor data regarding usage and operation of the vehicle by the driver to generate one or more vehicle sensor data objects 304, 308. When combined, the vehicle sensor data and the identifier associated with the registered user may be used by the driver authentication apparatus to generate training data for a model. The vehicle sensor data may include, for example, data associated with the driver captured by in-vehicle sensors, such as a driver weight captured by an in-seat weight sensor, retina scan captured by a camera, facial scan captured by a camera, fingerprint scan captured by a camera or other fingerprint sensor, a voice recording or other voice related data captured by a microphone, or the like. The vehicle sensor data object includes driving style, behavior, or habit (which terms may be used interchangeably) related data such as acceleration, speed, locations, brake rate, turning radii, usage of turn signals, and other data about vehicle operation that may vary between users. The vehicle sensor data object can include location data (e.g., GPS data, cellular location data, etc.) indicating where the vehicle has traveled or is traveling. The vehicle system 110 transmits the vehicle sensor data objects to the driver authentication apparatus 160. According to certain embodiments, vehicle sensor data could be stored on another device such as a server (not shown) and can be accessed by driver authentication apparatus 160 directly. According to certain embodiments, an application programming interface (API) is used to facilitate access to vehicle sensor data. While described as vehicle sensor data, one or more sensors of the user device may be used to generate at least a portion of the vehicle sensor data in some embodiments. For example, location data may be captured by the user device upon verification that the user device and vehicle are directly connected, thus confirming that the vehicle location corresponds to the user device. In addition, a user device (e.g., their phone) may provide microphone voice data, saved home location data, gyroscope data for steering angles, contact lists, call history, message history, or other data that can be used. In some implementations, data can be tagged as coming from a particular source, such as the vehicle or a personal device. Certain vehicle sensor data, such as the driver weight captured via a vehicle seat sensor, may necessarily be captured by the vehicle in instances in which the in-seat sensor is used. Moreover, in some embodiments, vehicle sensor data objects can be generated in response to raw signals from the vehicle system 100 or extra-vehicle signals, such as GPS data.

Various triggers can be implemented to initiate data collecting and training, and the data may be captured at various times and rates. For example, each time a user starts the vehicle, connects the user device to the vehicle, or initiates some other trigger initiating data collection for a new trip 301, the system may start collecting vehicle sensor data. In some embodiments, each new trip 301 data collection or other new data collection cycle may trigger or be triggered by a secondary verification of the vehicle driver (e.g., connecting the user device and/or vehicle system to the transactional system, such as via CARPLAY or ANDROID AUTO, or otherwise associating the registered user with the collected data). In some embodiments, the vehicle sensor data may be captured at different times and/or with different rates. For example, at least some vehicle sensor data may be captured once per trip (e.g., driver weight, which may be unlikely to change, or trip driving distance, which may not be complete until the trip has concluded) or with other periodic timings. In some embodiments, at least some vehicle sensor data may be captured continuously, including effectively continuously at a rapid sampling rate, such as once per second (1 Hz) or several times per second (e.g., 5, 10, 15, 20, 25, 30, 35, 40, 45, 50, 55, or 60 Hz). In some embodiments, at least some vehicle sensor data may be captured intermittently at predefined periods (e.g., every 5 minutes, every 10 minutes, etc.). Data collection rates and other data collection preferences may be individually per data type or globally. In some embodiments, the user device user interface and/or vehicle-based user device interface may present the user (e.g., driver) with various data collection permissions options and the user may select one or more data types for use in the authentication process. The driver authentication apparatus may thereby generate or update the driver authentication model based on the data.

The vehicle sensor data objects may be transmitted to the driver authentication apparatus 160 as they are generated or asynchronously with generation of the data (e.g., batched at various intervals, such as once per trip or each time a vehicle or user device is in range of Wi-Fi). In some embodiments, the vehicle sensor data objects may be transmitted together or at differing intervals.

At operation 310, the driver authentication apparatus 160 receives the one or more vehicle sensor data objects and may be associated with a first identifier associated with the registered user. The first identifier associated with a registered user or dual-registered user may be associated with each vehicle sensor data object or with a storage location corresponding to the first identifier. In some embodiments, the user device 100 and/or vehicle system 110 may explicitly transmit the identifier with or in association with the vehicle sensor data objects, or the driver authentication apparatus 160 can derive and associate the identifier with the received vehicle sensor data objects as described in further detail herein. The vehicle sensor data objects can be associated with the driver or operation of the vehicle by the driver for generating or training the model.

While in some examples, the driver authentication apparatus 160 receives data from vehicle sensors 118 directly connected (e.g., via wired or wireless connections) with the vehicle (e.g., an electronic control unit, infotainment system, other systems, or combinations thereof), in addition or instead data can be obtained via a dongle connected to a data port of the vehicle (e.g., an OBD port). That dongle can obtain and transmit the data to the driver authentication apparatus or another relevant system. In still further examples, the entity that manufactured or maintains the vehicle or a component thereof may operate a server that provides relevant vehicle data in response to API calls from third parties. For instance, the vehicle may routinely send data back to its manufacturer (or another entity) for any of a variety of purposes. Relevant data for processes described herein can be obtained by making a properly formatted call to the server storing such data.

At operation 312, the driver authentication apparatus 160 may generate one or more labels (e.g., if the data is not pre-labeled). The label may be based on a first identifier associated with a registered user or dual-registered user. The first identifier for a specific instance of a vehicle sensor data object (or a series thereof collected in a trip) can be explicitly provided by the vehicle system 110 or derived by the driver authentication apparatus 160 for labeling vehicle sensor data to be used in training.

According to certain embodiments, vehicle sensor data objects can be transmitted from the vehicle system 110 with a first identifier. For example, detection of a registered mobile device associated with a particular identifier associated with a registered user is transmitted with the vehicle sensor data object and is used as a label. In some embodiments, a vehicle identifier may additionally or alternatively be transmitted with the data or otherwise linked with the data (e.g., usable as a second label). If two or more mobile devices 102 are detected in the vehicle, a supplemental process can be used to determine which of two or more identifiers associated with respective registered users is associated with the driver. For example, a prompt can be provided to a driver, or users of the mobile devices requesting a user to confirm or deny they are driving or otherwise identify their location in the vehicle. Such prompts could be limited to a certain number of initial trips a registered vehicle makes, so as to collect a certain amount of data while not requiring extensive engagement of a driver or user. Additionally or alternatively when multiple mobile devices 102 are detected in a vehicle, vehicle sensor data can be used as described below to derive the identifier associated with a registered user.

If the first identifier of the registered user is not transmitted along with or in association with the vehicle sensor data object, the first identifier associated with the registered is derived by the driver authentication apparatus 160 in a variety of ways, such as based on a vehicle sensor data object, or identifying information of the vehicle that is communicated to the driver authentication apparatus 160. In some embodiments, unidentified vehicle data may be discarded and not transmitted to the driver authentication apparatus.

The driver authentication apparatus 160 may determine the identifier of a registered user with which the vehicle sensor data object is associated from the vehicle sensor data object itself, such as when the data can be used to reliably identify a driver (e.g., fingerprint, retina scan, and facial recognition not previously processed at the vehicle) or distinguish a driver from multiple identifiers associated with respective registered user registered with the vehicle (e.g., driver weight). In some embodiments, a user device identifier, such as an internet protocol address, associated with the user device may be used as a proxy to identify the registered user. The label for a vehicle sensor data object instance can therefore be populated with the identifier that the driver authentication apparatus 160 derives such that the vehicle sensor data object is associated with a known identity.

As another example, identifying information of a vehicle, such as a VIN programmed in the vehicle system 110 can be transmitted with or in associated with vehicle sensor data objects, such that the driver authentication apparatus 160 identifies one or more identifiers associated with respective registered user associated with the vehicle. If more than one identifier associated with registered users exists for the vehicle, the driver authentication apparatus 160 can identify the correct identifier with which the vehicle sensor data object is associated with based on other techniques described herein.

In some embodiments, the driver authentication apparatus 160 may generate additional data, such as synthetic variables based on the vehicle sensor data objects (e.g., synthetic vehicle sensor data objects). Such vehicle sensor data objects may include any data derivable from the received vehicle sensor data objects, including, but not limited to, common GPS locations, voice signature analysis outputs, correlations between two or more data points, and the like. In some embodiments, the driver authentication apparatus 160 may be configured to aggregate received vehicle sensor data objects to generate synthetic vehicle sensor data objects based on analyses, averages, and other combined outputs based on the aggregated data.

At operation 314, the driver authentication apparatus 160 generates (or updates, if already generated) the driver authentication model 162 with the vehicle sensor data object and the label. The generating or updating can take any of a variety of forms.

At operation 316, the driver authentication apparatus 160 trains the driver authentication model 162 to generate an authentication score indicative of a confidence level or other output associated with the identity of the driver of the vehicle. The driver authentication model 162 is trained to learn what vehicle sensor data objects are stronger or weaker indicators of a driver identity. In an example, sufficient data to train a full identity profile is not available or usable until sufficient verified driving sessions have occurred (e.g., customer may be presented with past five drives and dates and asked to confirm they were the driver during these trips). Certain parameters may be treated differently during the labeling and parameterization portion of model training. For example, a driver weight can be expected to have minimal changes day-to-day and therefore have a lower tolerance to changes, and location data can largely expected to be within a set number of neighborhoods, gathered over the first X number of trips. Whereas certain other driving factors (e.g., speed changes, lane merge speed, turning radius, and others) may have a higher tolerance for variance. Such variability can affect an amount of data needed to be collected prior to being able to generate or update the model.

Weights are applied to various features of the driver authentication model 162 so the model is trained utilizing a machine learning algorithm, to generate an authentication score indicating the likelihood of a certain instance(s) of a vehicle sensor data object matches a one or more subject identities. In some embodiments, the model output may be an authentication indication defining a raw authentication score or a determination based on the authentication score or other intermediate output (e.g., a confidence that the driver matches a queried driver identity or an affirmative determination of the identity of the driver from a group of one or more drivers).

As indicated by the arrow from operation 316 to 310, the operations may be repeated over a period of time, such as for a plurality of vehicle trips of the driver, multiple trips of the driver, or every time a vehicle is driven. The driver authentication model 162 can evolve and develop over time, and adjust to new habits of a driver, such as by learning new driving routes or schedules on which certain routes are commonly driven. In this regard, the driver authentication model is continually or periodically updated with new sensor data while being ready to receive an authentication request data object at any time. Similarly, in some embodiments, older vehicle sensor data objects may be decayed and their influence on the driver authentication model may be in favor of newer vehicle data. Additionally, the driver authentication model 162 distinguishes between multiple drivers of the same vehicle by learning respective driving habits and the like. Although some user interaction with a user device, mobile device, or vehicle-based user device may be needed for setup or for a few instances after it is registered, the training and evolution of the driver authentication model 162 is significantly passive from the perspective of a driver or user. In this regard, no intentional engagement of the driver or user is required, other than operating the vehicle as usual, for at least some iterations of the vehicle sensor data collection and the training of the driver authentication model 162. In some embodiments, segments of data may be ported between vehicles and may be linked to a driver profile independently of a specific vehicle (e.g., voice data, facial recognition data, etc.) such that multiple vehicles may provide data to train the model and model training data may be at least partially retained after a user switches or sells vehicles.

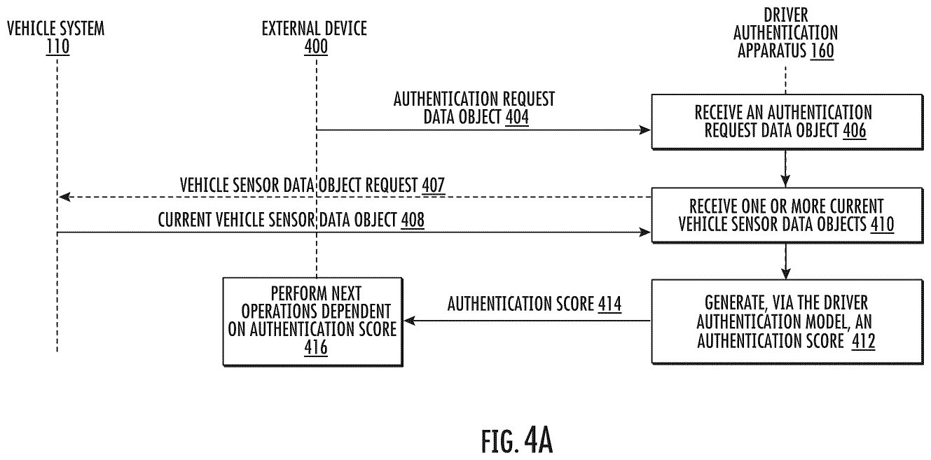

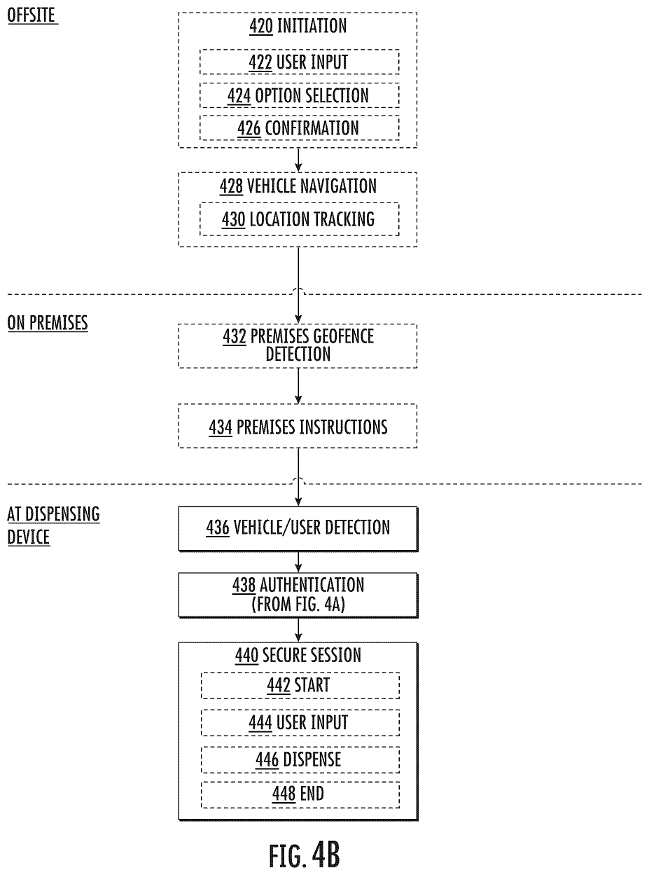

FIG. 4A is a sequence diagram illustrating an example process of an external device 400 requesting authentication of a driver from the driver authentication apparatus 160. The external device 400 may include any computing entity or system configured to request authentication of a driver, including those examples described herein. The external device 400 can include, without limitation, a transactional system 120, a vehicle system 110, a dispensing control system 122, a payment server 140, a proximity-based terminal 142, a vehicle detection system 150, an on-premises transceiver 152, or a gateway control system 170. For example, the authentication request may be received from a vehicle, such as to implement a proximity-based vehicle key.

At 404, an authentication request data object may be transmitted from the external device 400 to the driver authentication apparatus 160. The authentication request data object can include one or more subject user identifiers. For example, the authentication request data object can include a subject user identifier associated with a registered user for which authentication is requested. According to certain embodiments, the authentication request data object can include multiple subject user identifiers associated with a vehicle. An authentication request data object can be generated in response to a variety of triggers. For example, the authentication request data object can be generated and transmitted in response to a vehicle detection system 150 or proximity-based terminal 142 detecting a vehicle at the establishment. An authentication request data object can be generated and transmitted in response to initiation of a transaction, in response to a user-initiated request via mobile device 102, vehicle-based user device 114, or the like. An authentication request data object can be generated and transmitted in response to receipt of a transaction initiation data object.

At operation 406, the driver authentication apparatus 160 receives the authentication request data object. According to certain embodiments, the authentication request data object comprising at least one subject user identifier associated with a subject identity for which authentication is requested.

At operation 410, the driver authentication apparatus 160 receives one or more current vehicle sensor data objects, such as generated by at least one or more vehicle sensors of a vehicle. The vehicle system 110 transmits the one or more vehicle sensor data objects automatically or in response from a request from the external device 400 or driver authentication apparatus 160. For example, in some embodiments, the one or more current vehicle sensor data objects may be transmitted in response to a request 407 sent by the driver authentication apparatus 160. In various embodiments, the driver authentication apparatus 160 may additionally or alternatively use a most recent vehicle sensor data object (e.g., retrieving a most recent vehicle sensor data object in an instance in which the vehicle is continuously transmitting data to the driver authentication apparatus 160). The current vehicle sensor data objects are associated with a current driver identity.

At operation 412, the driver authentication apparatus 160 generates, via the driver authentication model and based on the one or more current vehicle sensor data objects, an authentication score, the authentication score indicative of a likelihood that the one or more current vehicle sensor data objects matches the driver associated with the first identifier associated with a registered user.

The one or more subject entities are associated with one or more subject entity identifiers that are particular instances of identifiers of respective registered users and may be explicitly communicated in or with the authentication request data object. For example, in an instance in which the transactional system 120 is executing a transaction, the subject identifier may indicate the user associated with the transaction, and the transactional system and/or the driver authentication apparatus 160 may identify one or more vehicles associated with the subject identifier for analyzing the current vehicle sensor data object to confirm the identity of the driver. According to certain embodiments, the authentication score indicates a likelihood that a current driver identity associated with the one or more current vehicle sensor data objects matches the driver associated with the first identifier associated with the registered user. In some embodiments, the authentication request data object may additionally or alternatively include a vehicle identifier configured to cause the driver authentication apparatus to request and/or receive current vehicle sensor data objects associated with the indicated vehicle.

Additionally or alternatively, the driver authentication apparatus 160 may derive one or more subject user identifiers similarly as described with respect to operation 312. For example, in some embodiments, if the one or more subject user identifiers are not transmitted along with or in association with the vehicle sensor data object, the associated subject user identifier(s) (instances of identifiers associated with registered users) may be derived by the driver authentication apparatus 160 in a variety of ways, such as based on a vehicle sensor data object, data transmitted from a mobile device 102, or identifying information of the vehicle that is communicated to the driver authentication apparatus 160. According to certain embodiments, such data can be transmitted from the mobile device 102, optionally to the vehicle system 110, and to the driver authentication apparatus 160.

The driver authentication apparatus 160 applies the current vehicle sensor data objects to the driver authentication model 162 to generate the authentication score indicating the likelihood that the current driver identity associated with the one or more current vehicle sensor data objects matches one or more subject identities. In some embodiments, each driver authentication model may be generated in association with one driver, such that the model associated with the subject identifier is retrieved and used to process the current vehicle sensor data objects. In some embodiments, a single model may be configured to identify a driver from among two or more drivers or the driver authentication apparatus 160 may apply the current vehicle sensor data object to multiple models.

At operation 414, the driver authentication apparatus 160 transmits the authentication score or another authentication indication (e.g., a driver name, a binary positive or negative signal, or the like) toward the external device 400. At operation 416, the external device performs next operations dependent on score authentication score. For example, if the authentication score is lower than a predefined threshold or otherwise indicates a lack of authentication of the driver, a supplemental or alternative authentication procedure can be invoked, or a transaction or other operations can be prevented from proceeding. For example, a standard security procedure (e.g., manual identity verification, user login credentials, presentation of a card or other device, etc.) may be applied by the on-premises system in an instance in which the driver is not authenticated, and in an instance in which a driver is authenticated, the security procedure may require no further input or a reduced input, such as a PIN entry, which may be defined as a reduced or expedited security procedure. As described herein, the reduced or expedited security procedure achieved via the authentication processes of various embodiments may provide improved security over a standard security procedure.

In embodiment in which a driver is authenticated, expedited downstream transaction and security procedures may be used in accordance with the embodiments discussed herein. According to certain embodiments, an authentication score can be used to determine or judge appropriateness of a transaction for a particular device type, such as an ATM, secure lock, pneumatic tube device, or the like (e.g., each dispensing device may include a different authentication score threshold).

For example, when external device 400 is implemented as a gateway control system 170, the system performs the operations to enable, maintain, or prevent establishment of a secure communication session. In a circumstance the authentication score satisfies a predetermined threshold, the gateway control system 170 establishes a secure communication session, associated with the at least one subject user identifier, between at least one of (a) a mobile device or (b) a vehicle system of the vehicle (e.g., using CARPLAY or ANDROID AUTO in some embodiments discussed herein), and an external device. According to certain embodiments, an authentication score can be used to maintain an already established secure communication session.

According to certain embodiments, operation 416 includes transmitting an authentication success indication in an instance in which the authentication score indicates a match between the one or more current vehicle sensor data objects matches the driver associated an identifier associated with a registered user associated with a driver and a vehicle. According to certain embodiments, in response to the authentication success indication, the at least one transactional system is configured to apply a reduced security protocol to a transaction or communication session.

According to certain embodiments, operation 416 includes, in response to an authentication failure indication, applying a standard security protocol to the transaction, wherein the reduced security protocol comprises at least one fewer security input than the standard security protocol.

According to certain embodiments and in a circumstance the authentication score does not satisfy the predetermined threshold, the gateway control system 170 performs at least one of: (a) preventing, at least temporality, establishment of the secure communication session, or (b) initiating a supplemental authentication procedure. The supplemental authentication procedure can include various procedures including but not limited to prompting a user for a PIN via a vehicle-based user device 114, user device 100, or mobile device 102. The supplemental authentication procedure can include one or more non-vehicle-based security procedures).

A secure communication session can be established to enable a variety of interactions and to execute a transaction. Based on the secure communication session, a driver can interact with an external device via the vehicle-based user device 114. Accordingly, in the circumstance the authentication score satisfies the predetermined threshold, the secure communication session enables user interaction via the at least one of (a) the mobile device or (b) a vehicle-based user device of the vehicle system, and the external device. For example, the user can access financial data or other information.

The driver could initiate an ATM withdrawal, check order, grocery order, or the like, via the vehicle-based user device 114 and over the secure communication session, and the driver authentication apparatus 160 may concurrently or later authenticate the driver (e.g., when arriving at the establishment). In this regard, the gateway control system 170 receives, at a first time instance, a transaction initiation data object comprising at least one subject user identifier associated with the subject identity. For example, a user can place an order for checks, food, or the like, or indicate a desire to conduct an ATM transaction in the future, or the like. A driver can use the vehicle system 110 voice control, via a microphone, or other user interface element to initiate a transaction. The intent or request, and corresponding transaction initiation data object can be generated prior to a vehicle arriving at the establishment, such as via a user device, mobile device, vehicle-based user device, or the like. At a second time instance, the gateway control system 170 receives a detected vehicle data object associated with the transaction initiation data object. In some example embodiments, the authentication request data object is generated in response to receiving the detected vehicle data object. Accordingly, processes can be initiated differently. For example, the transaction may occur on the vehicle-based user device 114 or mobile device 102 at the first time instance. At the second time instance, the authentication request data object can be initiated from the transactional system 120 or the like to fulfill the transaction. Between the first time instance and the second time instance, the gateway control system 170 may monitor location data associated with the vehicle, wherein the location data is utilized to generate one or more instruction data objects and provides one or more instruction data objects via the secure communication session (e.g., for display via the user device 100 and/or vehicle-based user device 114). For example, the driver's journey toward the establishment where an order will be retrieved or a transaction otherwise executed can be monitored to assist the establishment in preparing for the order. Navigation information can be provided (e.g., coordinates, turn-by-turn directions, or the like). If different branches or locations of an establishment are available, the driver can be presented with the different options and make a selection. The options may include filtering the locations by service or product availability (e.g., only those locations having the product for which the user has selected). An instruction data object can be provided to the vehicle system based on its location and proximity. According to certain embodiments, a marketing opportunity or other offer for purchase can be provided.

According to certain embodiments, in addition to establishing a secure communication session, and further in the circumstance the authentication score satisfies the predetermined threshold or otherwise returns a positive authentication indication, the gateway control system 170 may execute a transaction via the external device. According to certain embodiments, such execution of a transaction could occur automatically in response to successful authentication. For example, a driver could order a product that requires an immediate payment. The driver can provide instructions such as by voice activation or the like via their vehicle system, and once authenticated, the transaction is executed or queued for execution upon arrival of the user at the pickup location (e.g., a dispensing device 124).

According to certain embodiments, in the circumstance the authentication score satisfies the predetermined threshold or otherwise returns a positive authentication indication, the secure communication session sends a trigger signal configured to cause or enable dispensing of a product or currency at a dispensing device 124 or is configured to trigger dispensing of a product or currency at a dispensing device 124. Currency can be provided via an ATM, pneumatic tubes, or lockers. Other products can be dispensed by providing access to a locker.

As another example, detection of a vehicle on the premises of the establishment may first occur to initiate the secure communication session and/or transaction execution. For example, according to certain example embodiments, the external device 400 such as the gateway control system 170 receives a detected vehicle data object, and the authentication request data object is transmitted at operation 404 in response to receiving the detected vehicle data object. Accordingly, the external device 400 becomes aware a vehicle has arrived on the premises of an establishment, and can perform additional operations accordingly. In scenarios in which a driver pre-orders an item but does not pay in advance, the transaction executes upon arriving at the establishment, based on the received detected vehicle data object.

Closing of a secure communication session can occur in response to one or more actions. For example, once a product is delivered to a vehicle or retrieved from a dispensing device 124, the session is ended. As another example, a driver can indicate to end the secure communication session. Numerous variations and use cases can be contemplated.

FIG. 4B illustrates an example transaction process flow that integrates the authentication process of FIG. 4A. Reference to system components refer to the embodiment shown in FIG. 1. In the depicted embodiment, the user initiates 420 a transaction flow with a user input 422. The transaction flow may be initiated offsite (e.g., not necessarily at a premises of an establishment, and in various embodiments, at any location). The user input may be made, for example, via the vehicle system 110 and/or via the user device 100 (e.g., via voice command, text input, touchscreen input, and/or the like) using a software application associated with a transactional system. The user input 420 may include a specification of a transaction type (e.g., go to an ATM, order a product, etc.). In some embodiments, the user may be presented with one or more options associated with the selected transaction type (e.g., location, timing, quantity or other details about the requested transaction type, or the like), which options may be presented via audio output and/or visually via a display of the vehicle-based user device 114 and/or user device 100). The user may then select one or more desired options 424 and receive a confirmation 426 of the transaction details. In some embodiments, as discussed below, at least a portion of the transaction related information may be input by the user at a later time.

Following initiation 420 of the transaction flow, the user may be presented with an option to navigate the vehicle to the premises of the establishment 428 or the vehicle may automatically begin navigation. In embodiments in which the transaction occurs at a later time, the user may receive a reminder or alert when the transaction time is approaching (e.g., within a driving time to the premises), and navigation instructions may be provided at that time. The navigation may be generated via the user device 100 (e.g., on a user's phone or via a passthrough process such as APPLE CARPLAY or ANDROID AUTO) and/or the vehicle system 110 (e.g., via a vehicle-based navigation service) and displayed on either the user device or the vehicle-based user device 114.

In some embodiments, the transactional system 120 and/or one of the user device 100 and/or vehicle system 110 may track the user's location to initiate various processes herein when the user arrives at the premises or is within a predetermined time and/or distance of the premises.

In some embodiments, when the user arrives at the premises, the transactional system 120 may detect the arrival of the user or user vehicle 432. For example, the aforementioned location tracking 430 may be used by transactional system 120 and/or one of the user device 100 and/or vehicle system 110 to detect the user's or vehicle's reported location crossing into a geofence associated with the premises of the establishment. In some embodiments, the establishment may include one or more sensors that detect the arrival of the vehicle and/or user (e.g., one or more camera-based systems of a vehicle detection system 150).

In some embodiments, when the user has arrived at the premises or at another predetermined time during the transaction flow, the transactional system 120 may cause the vehicle system 110 and/or user device 100 to present instructions 434 to the user to facilitate the transaction. For example, the transactional system may transmit a smart spot number, a drive thru lane number, a locker number, or another indication of where on the premises to proceed to reach the dispensing device 124. In some embodiments a map or other graphical representation may be provided by the aforementioned user device 100 and/or vehicle-based user device 114.

Once the user and/or vehicle arrives at the dispensing device 124, the user and/or vehicle may be detected by the transactional system 120 (e.g., detected in proximity to the dispensing device 124). In some embodiments, the transactional system 120 may include one or more sensors embodied in a vehicle detection system 150 configured to detect the user and/or vehicle, such as the UWB transceiver 152a of a terminal 142 as discussed below or a camera based recognition system configured to recognize a vehicle (e.g., via license plate, VIN, or another image recognition process). In some embodiments, the user may take some action to identify herself to the transactional system, such as scanning a QR code, inputting data into a user interface of the transactional system (e.g., into a dispensing device user interface), or otherwise transmitting a signal to the transactional system 120.

In some embodiments, once the user and/or vehicle are detected in proximity to the dispensing device 124, the transactional system may initiate an authentication process 438, such as by inputting current vehicle sensor data objects into the driver authentication model as discussed herein (e.g., from the process illustrated in FIG. 4A). Upon completion of authentication, and corresponding to the next operations 416 illustrated in FIG. 4A, the transactional system may start 442 a secure session 440 with the user via the user device 100 and/or vehicle system 110 to complete execution of the transaction. In some embodiments, the authentication process may occur at a different time in the workflow, such as upon entry onto the premises, during the initiation process 420, or while the user is on their way to the location. As there are many pieces of information that will not substantially change during a trip, it is possible for the authentication model to run while the user is traveling to their destination. Upon arrival, authentication time could be reduced by simply checking that the information has not changed or running parts of the model against substantially new information rather than all information.

In some embodiments, the secure session 440 may request further user input 444. Non-limiting examples include requesting a user entry of a PIN, allowing a user to input a cash or other output quantity, or any other input associated with completing the transaction. The user input 444 may occur via an interface associated with the user device 100 and/or the vehicle-based user device 114. For example, during the initiation phase, a user may instruct the system, via interface associated with the user device 100 and/or the vehicle-based user device 114, to “take me to an ATM” and the user may not enter the cash amount required until arriving at the dispensing device 124, while in some embodiments, the user may instruct the system to “get me $30” at the initiation phase and the transactional system 120 may cause the interface to skip or request verification of the quantity at the dispensing device phase of the transaction. In an instance in which the transactional system 120 has received all available information for completing the transaction, and the user has been verified to be at the dispensing device 124, the transactional system 120 may trigger dispensing 446 of the transaction output to the user and end the secure session 448. Ending the session may, in some embodiments, include displaying a confirmation or receipt of the transaction and/or sending such confirmation or receipt to the user (e.g., via email).

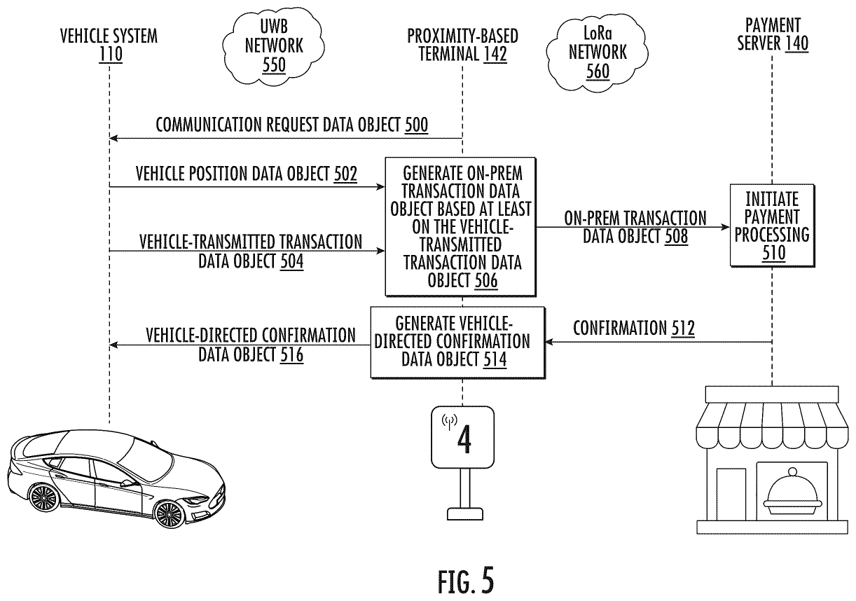

FIG. 5 is a sequence diagram illustrating a process of facilitating a vehicle-based payment in accordance with some embodiments of the present disclosure. In some embodiments, the vehicle may act as a secure transaction device that avoids the need for additional steps or devices (e.g., cards, etc.) to facilitate authentication and authorization. In an example, throughout a drive, the driver is granted vehicle authentication tokens that are authorized for a predetermined amount of time. This authorization can be refreshed or authentication redetermined at predetermined intervals during the drive (e.g., a predetermined number of miles or minutes of time passed). When the vehicle enters a space or other area with the car-as-card payment technology enabled, a transaction request is pushed wirelessly to the vehicle. If the vehicle lacks authorized authentication tokens, then the vehicle can decline the request and inform the user accordingly (e.g., and prompt them to use another form of authentication or payment). If the vehicle has authorized authentication tokens for the driver, then the vehicle provides the transaction details at the infotainment screen and receives a selection of one of their stored payment methods to be used with the transaction. Once the transaction is confirmed, the payment token and the currently active authentication token are pushed to the smart space UWB receiver. This data is then passed along to the establishment's network (e.g., first over a LoRa gateway and then via WI-FI, Ethernet, or another protocol). In examples, the merchant can batch transactions, with the token being authorized by the authentication token for that merchant for that specific time window.

A vehicle can be configured for such use through any of a variety of processes. In an example, after a sufficient identity threshold has been met (e.g., see driver authentication techniques elsewhere herein), the user can be prompted (e.g., via their cellphone or a system of the vehicle) to enroll payment data. The system can then receive card information from the user or a device of the user, and a payment tokens are created for the entered payment options. If the payment tokens are not located at the vehicle, then once the tokens are available, the user is given the option to start the synchronization process with the vehicle. Once the user begins the synchronization process, the user is prompted to add data of the tokenized payments to the vehicle either directly or via wired or wireless connection to another device. The payment tokens are then stored at the vehicle (e.g., at the vehicle's infotainment system).

As an example, a vehicle arrives on-premises at the establishment and parks in a smart spot location. According to certain embodiments, a vehicle detection system 150 detects the vehicle and wakes a terminal 142, such as a terminal comprising the on-premises transceiver 152. In some embodiments, the vehicle detection system 150 may include at least one circuit within the terminal 142 that may detect the vehicle. For example, the vehicle may be detected using any of various processes described herein, including but not limited to, listening for and/or broadcasting wireless transmissions with the vehicle (e.g., via the vehicle detection system 150 and, in some embodiments, a circuit within the terminal 142); capturing one or more images with a camera based sensing process that detects and, in some embodiments, identifies a vehicle; other physical sensors, such as an inductive sensor or pressure sensor beneath the smart spot; or the like. In some embodiments, the vehicle transceiver 116 (shown in FIG. 1) may be configured to continuously transmit a UWB signal, at least upon entry onto the premises or proximity to the smart spot, which may be detected by a terminal 142 when in range. In some embodiments, the vehicle detection system 150, including optionally the circuitry of the terminal 142, may include location detection with sufficient resolution to detect the location of the vehicle (whether or not the vehicle is specifically identified by type, registered user, etc.) in the smart spot. In embodiments using a portion of the terminal 142 as part of the vehicle detection system 150, other portions of the terminal 142 may be optionally placed in a low power state or turned off while awaiting a detection trigger signal. Additionally (such as in response to vehicle detection and waking the terminal) or alternatively, as shown in operation 500, the on-premises transceiver 152 transmits a communication request data object that is received by the vehicle transceiver.

A communication path may be established between the vehicle transceiver 116 (shown in FIG. 1) and the on-premises transceiver 152, and the two transceivers communicate via a first communication protocol, such as UWB communication protocol over UWB network 550, which can include portions of network 190.

For example, as discussed herein, the UWB communication protocol may be efficient and accurate for positioning. With reference to operation 502, the vehicle system 110 or the proximity-based terminal 142 (or a system or device connected to the terminal) generates vehicle position data based on the data communicated between the vehicle transceiver 116 and the on-premises transceiver 152. The vehicle position data object includes information regarding the vehicle's position on the premises of the establishment. In some embodiments, the vehicle position data may be programmatically inferred. For example, a UWB radio may have a sufficiently short range that one or a small number of terminals may communicate with a vehicle at a time, thus allowing the transactional system to determine the location of the vehicle based on a known location of the respective terminal(s). In instances in which one terminal detects one vehicle, the location may be assigned as the smart spot in front of the terminal. In instances in which multiple terminals are within range of a vehicle, a signal strength or triangulation-based location detection technique may be used to determine the vehicle location. For example, if five terminals are each respectively placed in front of one of five smart spots arranged in a line, and the three middle terminals detect a UWB signal from a vehicle while the outer two terminals do not, the position of the vehicle may be determined to be the central smart spot based on the known locations of the five terminals. In some embodiments, a user may initiate a secure session with the transaction system 120 and enter (e.g., via a user interface associated with the user device 100 or vehicle-based user device) a smart spot number or otherwise connect with the transaction system. An establishment may include any number of terminals positioned in any configuration relative to vehicle parking spots while facilitating position detection.

In some embodiments, one or more additional authentication steps may be performed to validate and execute the transaction, including any of the authentication processes described herein. For example, upon establishing a communication path between the terminal 142 and the vehicle system 110, the vehicle driver may be prompted (e.g., via a display associated with the user device 100 and/or vehicle-based user device) to enter a spot number (e.g., “4” in the embodiment of FIG. 5) to verify that the vehicle corresponds to the particular transaction being executed. In some embodiments, the transaction may be authenticated using the driver authentication model discussed herein.

As shown in operation 504, the vehicle system 110 generates and causes transmission of a vehicle-transmitted transaction data object to the on-premises transceiver of the terminal via the first communication protocol, such as UWB communication protocol. The proximity-based terminal 142 receives the vehicle-transmitted transaction data object via the on-premises transceiver 152 and via the first protocol. The distance over which the vehicle-transmitted transaction data object is transmitted from the vehicle transceiver to the on-premises received may include a first distance. In some embodiments, the vehicle-transmitted transaction data object may include user and/or transaction data configured to be processed to execute a payment or other transaction.

As shown in operation 506, the proximity-based terminal 142 generates an on-premises transaction data object in a format compatible for transmission via a long-range protocol (e.g., LoRa) that is different than the first protocol. In an example, the UWB transceiver receives precise information about the vehicle and the vehicle's location, which is used to determine that the vehicle is correct. Once that confirmation is made, the data can be converted into simple components (e.g., authorization token, authentication token, payment token, space number, time received, other components, or combinations thereof) and sent to the LoRa gateway, which transmits it over a longer distance. It can be possible to make these the same device but as multiple UWB endpoints can use a singular LoRa gateway.

At operation 508, the on-premises transaction data object is transmitted, such as by the on-premises transceiver 152 (e.g., LoRa transceiver 152b), and via LoRa network 560 (also referred to as a LoRa gateway), which can include portions of network 190, to a payment server 140 such as one configured inside the establishment. The distance over which the on-premises transaction data object is transmitted may be a second distance greater than the first distance. The on-premises transaction data object includes payment details and optionally data derived from the vehicle position data object. Alternatively, vehicle position data can be separately generated at the proximity-based terminal 142 in a format configured for the long-range protocol or another system or device (e.g., associated with the establishment) may provide the vehicle position data. According to certain embodiments, such as when the establishment does not need precise vehicle positioning information, the vehicle position data is not forwarded to the payment server 140.

The payment server 140 may include one or more local computing devices (e.g., one or more devices at the premises of the establishment) configured to facilitate transaction processing as discussed herein. At operation 510, the payment server 140 initiates payment processing of the on-premises transaction data object. The payment server 140 can process the on-premises transaction data object in the same manner that it processes payments that originate from an interaction of a physical credit card or alternative payment type. The processing can include transmitting or forwarding data to an off-premises payment processing system for further processing (not shown in FIG. 5). In this regard, updates to existing payment servers are not needed to integrate the vehicle system 110 and the proximity-based terminal 142 as presented in FIG. 5 and described herein according to example embodiments. In some alternative embodiments, the payment server 140 may include one or more remote (e.g., not on premises) devices that may communicate directly with the terminal via wired or wireless connection, for example, in an embodiment not using the LoRa network.

As shown by 512, the payment server 140 returns a confirmation (or decline message), toward the proximity-based terminal 142 over the long-range protocol. As used herein, long-range refers to longer than the first protocol.

Although not depicted in FIG. 5, the transactional system 120 associated with the payment server 140 can further process the on-premises transaction data object and vehicle position data object and such processing can be dependent on a confirmation from its payment processing service. Additional processing may be further dependent on a vehicle position data object. For example, the transactional system 120 can assess traffic flow through multiple drive-through lanes and generate an instruction data object with specific instructions tailored for a driver, such as which lane or window to access (e.g., in an embodiment in which the terminal and smart spot are positioned in or adjacent a drive-through area). Locker QR codes can be generated to provide access if the driver is authenticated, and the transaction is confirmed. Subsystems of the transactional system can notify delivery staff to prepare a delivery and indicate a delivery location such as a parking spot or identify the vehicle and/or driver for a drive-through. A dispensing control system 122 can be activated to enabling dispensing via the dispensing device 124. A particular dispensing device or ATM can be identified from multiple dispensing devices, and associated with a transaction or vehicle, using a vehicle position data object generated based on the data communicated via the UWB protocol and its associated positioning capabilities. In some embodiments the terminal 142 may include a dispensing device 124. Numerous variations can be contemplated, and any instruction data objects can be sent along with the confirmation at 512.

As shown by operation 514, the proximity-based terminal 142 may generate a vehicle-directed confirmation that can optionally include the instruction data object. According to certain embodiments, the vehicle-directed confirmation indicates a successful transaction or payment. The vehicle-directed confirmation is generated according to a format compatible with the first communication protocol, such as UWB.

At operation 516, the vehicle-direct confirmation data object may be transmitted from the on-premises transceiver 152 of the proximity-based terminal 142. The vehicle transceiver 116 receives the data and can display a confirmation and optional instruction via the vehicle-based user device 114.

For the depicted transaction in FIG. 5 and for various other transactions, although not depicted in FIG. 5, authentication can occur in accordance with several embodiments, such as according to example embodiments described with respect to FIG. 4A, and according to embodiments disclosed herein. Authentication using the driver authentication apparatus 160 can occur at different points in the sequence of FIG. 5. For example, when the communication request data object is received, the vehicle system 110 can initiate a separate process in which the driver is authenticated, such as by communicating with the driver authentication apparatus 160.

Additionally or alternatively, vehicle sensor data objects can be transmitted via the vehicle transceiver 116 and on-premises transceiver 152, resulting in the transactional system 120 initiating an authentication request data object toward the driver authentication apparatus 160, such as described with respect to FIG. 4A.

According to certain embodiments, the vehicle system 110 generates an authentication request data object and causes transmission of the authentication request data object to the on-premises transceiver via the UWB communication protocol.

According to certain embodiments, the vehicle system 110 and/or driver authentication apparatus 160 generates an authentication score using one or more current vehicle sensor data objects, wherein the transaction data object is transmitted to the on-premises transceiver via the UWB communication protocol and/or the payment server 140 in a circumstance the authentication score satisfies a predetermined threshold or otherwise indicates a positive authentication.

Variations of feedback provided via the vehicle system 110 may be implemented, such as depending on an authentication score or other authentication indication. An authentication failure message can be provided, or supplemental authentication procedures can be initiated before a sequence continues. For example, a driver may be prompted to additionally enter a PIN via the vehicle-based user device 114 or may be instructed to present a card or other device either at the terminal or another physical device or within a building of the establishment.

One or more components depicted in FIG. 1 and described herein may provide one or more application programming interfaces (APIs) to enable other systems to perform various processes as a result of the operation described herein. Accordingly, the APIs may be used to facilitate communication between and within the respective devices and systems discussed herein.

Numerous advantages and improvements to systems and components thereof are provided according to the present disclosure. Various aspects of disclosed embodiments enable authentication and facilitation of a secure communication session and a transaction to be initiated from a vehicle system. The operations disclosed herein pertaining to authentication can be performed passively with little or no driver engagement beyond the driving experience used to drive a vehicle, providing a safe and low impact to the user while providing improved security over conventional security processes. Certain operations pertaining to authenticating users (and drivers) and executing a transaction can be performed with reduced user involvement in comparison to alternative methods. For example, when considering ATM usage, fewer interactions from a user are needed, in comparison to what is required with traditional ATM implementations in which a user reaches from their vehicle window to swipe a card, enter PIN, otherwise engage with the ATM, or the like.

Example embodiments provided herein provide a reliable method for authenticating drivers using the driver identification model that is trained over a period of time to account for changing or evolving driving habits, changes in commonly navigated routes by a driver, and the like. In the various embodiments herein, the driver authentication apparatus 160 may be configured to respond to an authentication request (e.g., via API) from one or more external systems at any given time and in real time or near real time. These responses need not interrupt the ongoing model training and improvement process. In some embodiments, no additional information may be needed from the vehicle at the time of processing an authentication request, and the driver authentication apparatus may query most recent data from its memory instead of or in addition to directly retrieving the current vehicle sensor data objects from the vehicle system. In some embodiments, the driver authentication system may retrieve the current vehicle sensor data objects directly from the vehicle (e.g., via sampling an outbound stream (whether continuous or intermittent) of vehicle sensor data from the vehicle system and/or via requesting and receiving the current vehicle sensor data objects as additional send/receive steps). Example embodiments provide an added layer of security beyond alternative methods in which a driver's identity is authenticated, and an added layer of security beyond alternative methods that enable a driver of a vehicle to initiate a transaction using the vehicle system. In some instances, such as when a vehicle is off or a user or user device is not in the vehicle, the driver authentication apparatus may return a null or negative answer in response to a driver authentication request. Providing the added security layer according to embodiments disclosed herein provides for reduced risk of error, failure, or other issues such as fraud.

Improvements are therefore realized at the vehicle-based user device 114, the vehicle system 110, the dispensing device 124, the transactional system 120, and other components illustrated in FIG. 1 and discussed herein. Accordingly, the overall system of FIG. 1 is improved by the provision of the proximity-based terminal 142 and the on-premises transceiver 152, driver authentication apparatus 160, driver authentication model 162, and gateway control system 170, other components discussed herein, as well as example embodiments disclosed herein.

### Machine Learning Framework

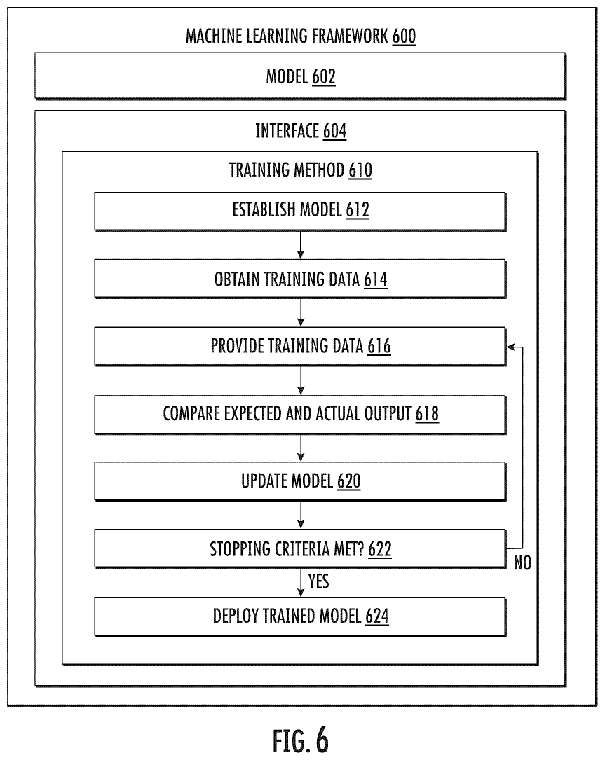

FIG. 6 illustrates an example machine learning framework 600 that may be used in accordance with various embodiments of the present disclosure and that techniques described herein may benefit from or improve on. For example, the depicted machine learning framework 600 may be used for generation and execution of the driver authentication model 162. A machine learning framework 600 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 600 or components thereof are often built or refined from existing frameworks, such as TENSORFLOW by GOOGLE, INC. or PYTORCH by the PYTORCH community.

The machine learning framework 600 can include one or more models 602 that are the structured representation of learning and an interface 604 that supports use of the model 602.

The model 602 can take any of a variety of forms. In many examples, the model 602 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 602 can include a representation of memory (e.g., providing long short-term memory functionality). Where the set includes more than one model 602, the models 602 can be linked, cooperate, or compete to provide output.

The interface 604 can include software procedures (e.g., defined in a library) that facilitate the use of the model 602, such as by providing a way to establish and interact with the model 602. For instance, the software procedures can include software for receiving input, preparing input for use (e.g., by performing vector embedding, such as using Word2Vec, BERT, or another technique), processing the input with the model 602, providing output, training the model 602, performing inference with the model 602, fine tuning the model 602, other procedures, or combinations thereof.

In an example implementation, interface 604 can be used to facilitate a training method 610 that can include operation 612. Operation 612 includes establishing a model 602, such as initializing a model 602. The establishing can include setting up the model 602 for further use (e.g., by training or fine tuning). The model 602 can be initialized with values. In examples, the model 602 can be pretrained. Operation 614 can follow operation 612. Operation 614 includes obtaining training data. In many examples, the training data includes pairs of input and desired output given the input. In supervised or semi-supervised training, the data can be prelabeled, such as by human or automated labelers in accordance with the various labeling processes described herein. In unsupervised learning the training data can be unlabeled. The training data can include validation data used to validate the trained model 602. Operation 616 can follow operation 614. Operation 616 includes providing a portion of the training data to the model 602. This can include providing the training data in a format usable by the model 602. The framework 600 (e.g., via the interface 604) can cause the model 602 to produce an output (e.g., a driver authentication score) based on the input (e.g., current vehicle sensor data objects). Operation 618 can follow operation 616. Operation 618 includes comparing the expected output with the actual output. In an example, this can include applying a loss function to determine the difference between expected and actual. This value can be used to determine how training is progressing. Operation 620 can follow operation 618. Operation 620 includes updating the model 602 based on the result of the comparison. This can take any of a variety of forms depending on the nature of the model 602. Where the model 602 includes weights, the weights can be modified to increase the likelihood that the model 602 will produce correct output given an input. Depending on the model 602, backpropagation or other techniques can be used to update the model 602. Operation 622 can follow operation 620. Operation 622 includes determining whether a stopping criterion has been reached, such as based on the output of the loss function (e.g., actual value or change in value over time). In addition or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 614. If the stopping criterion has been satisfied, the flow can move to operation 622. Operation 622 includes deploying the trained model 602 for use in production, such as providing the trained model 602 with real-world input data and produce output data used in a real-world process. The model 602 can be stored in memory 214 (shown in FIG. 2) of at least one computer 210, or distributed across memories of two or more such computers 210 for production of output data (e.g., predictive data).

### Non-Limiting Example Embodiments

Non-limiting examples of transactions performable according to various embodiments of the present invention may include ATM-based transactions, pneumatic-tube based transactions, and/or locker-based transactions.

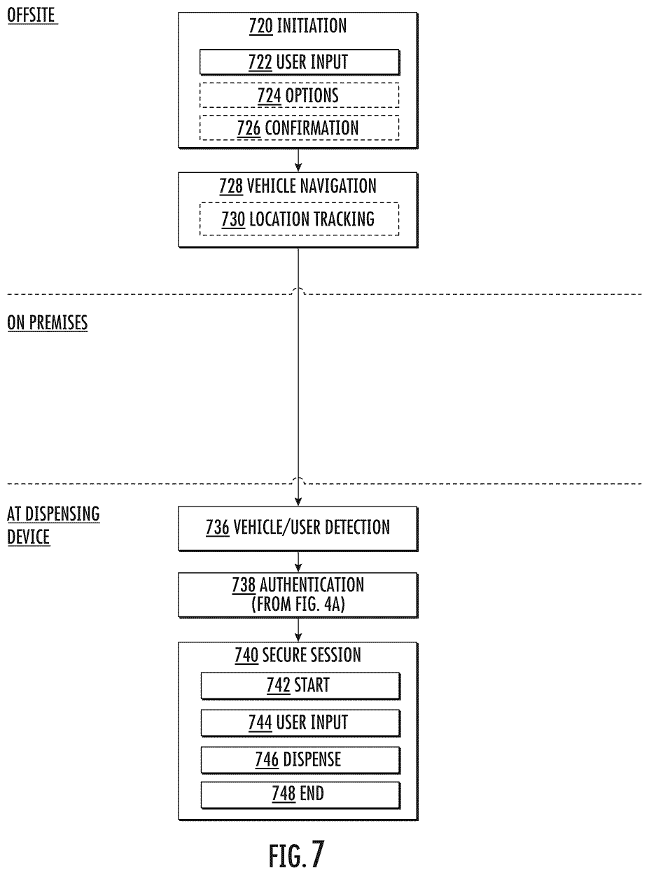

FIG. 7 illustrates a non-limiting example transaction flow for an ATM transaction. Initially, the user may be in her vehicle and may initiate 720 a transaction via the vehicle's vehicle-based user interface 114 communicating with the user's mobile device 102 (e.g., via APPLE CARPLAY or ANDROID AUTO). The user may initially use the vehicle's voice control to input a command 722 such as “Please take me to the closest ATM on my current route”. The vehicle may, in some embodiments, display a list of options 724 such as nearby ATMs along the current navigation route, which may include displaying additional details about the ATMs, such as business hours, in-network vs. out-of-network distinction, etc. Upon selection of an ATM, the vehicle may optionally display a confirmation 726 of the command and begin navigating 728 to the premises, in some instances, while tracking the location of the vehicle 730.

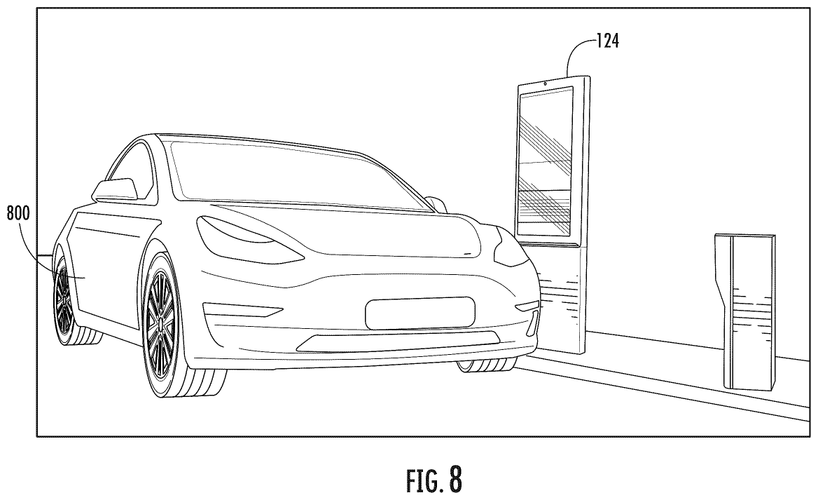

Upon arrival at the premises of the establishment, the user may drive to a nearby dispensing device 124 (e.g., a drive-up ATM), such as is shown in FIG. 8. FIG. 8 is an illustration of a scenario according to example embodiments, in which a vehicle 800, associated with a vehicle system 110, arrives at a dispensing device 124 which may additionally or alternatively function as a terminal 142. Upon arriving, a transaction may be performed, such as described with respect to FIGS. 4A-5. For example, the driver of the vehicle 800 may optionally interact with a user interface of the vehicle-based user device and/or with the dispensing device 124.

Referring back to FIG. 7, in the depicted embodiment, when the vehicle 800 enters the geofence associated with the premises and/or a geofence associated with the dispensing device 124 (e.g., ATM), a camera scans a license plate and/or VIN of the vehicle to detect the vehicle 736. At one or more of the various times discussed herein, the transactional system may request authentication 738 of the driver of the vehicle associated with the transaction. Example embodiments may determine a confidence of the authentication via current vehicle sensor data objects with or without further permission or interaction from the user. On a passing confidence level, authentication score (e.g., above a certain threshold), and/or other positive authentication indication, the interface indicates, “Welcome, Please follow the prompts on your device” or a similar message.

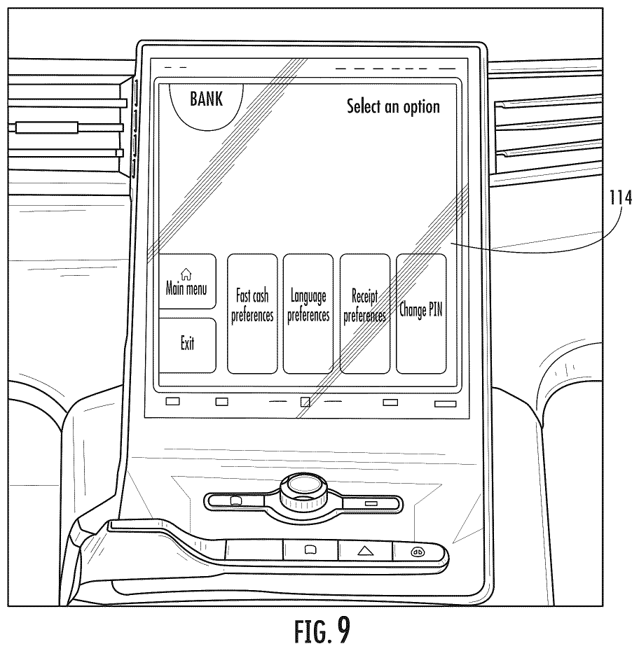

Following authentication, the transactional system 120 may initiate a secure session 740 with the user via the user device 100 and/or vehicle-based user device 114 to execute the transaction. In some embodiments, the non-physical portions of the transaction (e.g., one or more of the steps of the transaction other than physical receipt of the transaction output, such as a product, currency, or the like) may be carried out on a display associated with the user device 100 and/or vehicle-based user device 114. For example, the vehicle-based user device 114 and/or the user device 100 may indicate that a transactional system 120 associated with a dispensing control system 122 and dispensing device 124 is attempting to connect. When the user accepts the connection (or has previously authorized the connection), a secure, encrypted link 740 may be established, such as between the transactional system 120 and the user device 100 and/or vehicle's ECU 112. For example, the depicted interface of FIG. 9 may be rendered on the display of the vehicle-based user device based on rendering details provided by the user device 100 (e.g., via ANDROID AUTO or APPLE CARPLAY as discussed herein), while the user device 100 communicates with the transactional system 120. In some embodiments, the vehicle system 110 may communicate with the transactional system 120 to cause the interface to be displayed.

In the depicted example interface of FIG. 9, the vehicle-based user device may render a graphical user interface generally corresponding to an ATM interface. Via the in-vehicle display of the vehicle-based user device 114, various user inputs 744 may be received. For example, the user can navigate to a main menu, select fast cash options or preferences, language preferences, receipt preference, PIN change, or the like as would be available to a user of an external ATM. The user may be prompted for a PIN or authenticated as described herein according to certain example embodiments. In some further embodiments, the interface may prompt the user to enter the cash amount desired, if not specified earlier in the process. Numerous other operations and interactions can occur as described herein. Following entry of the user inputs 744, the ATM may dispense the requested cash 746 and the secure session may end 748, returning the vehicle-based user device interface to its previous configuration.

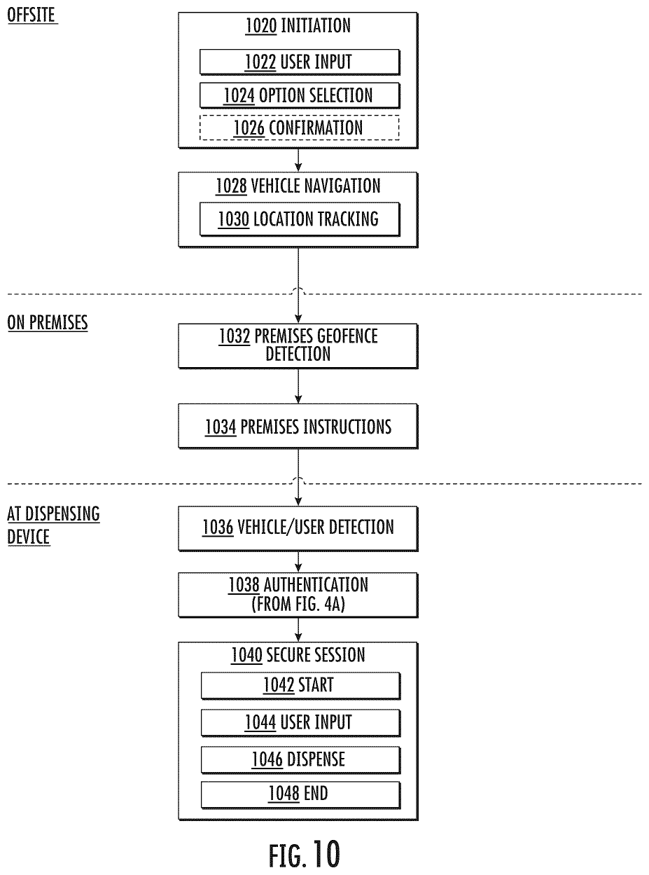

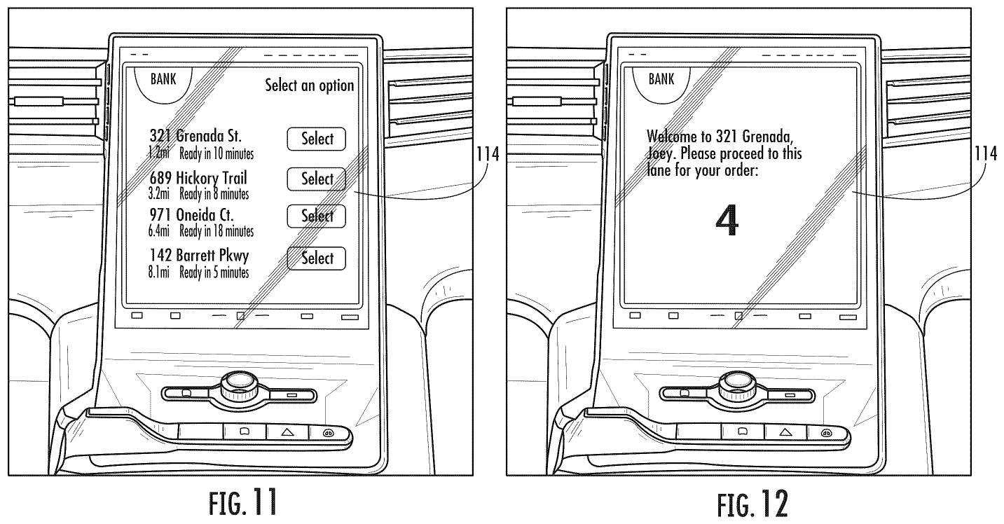

Turning to FIG. 10, another non-limiting example transaction flow is provided illustrating an example pneumatic tube transaction. Initially, the user may be in her vehicle and may initiate 1020 a transaction via the vehicle's vehicle-based user interface 114 communicating with the user's mobile device 102 (e.g., via APPLE CARPLAY or ANDROID AUTO). The user may initially use the vehicle's voice control to input a command 1022 such as “I need ten checks from the bank”. The vehicle may, in some embodiments, display a list of options 1024 such as nearby bank locations, teller hours, order delivery time, and/or distance. An example of such an interface is shown in FIG. 11.

According to an example illustrated in FIG. 11, a user can view a list of locations which may optionally include details such as teller hours and availability. The interface of the vehicle-based user device 114 of FIG. 11 may be displayed before or after the interface of FIG. 9 in an instance in which both options are presented. For example, the location options may be presented once a specific transaction is chosen (via FIG. 9) to identify the locations capable of executing the transaction. Then, the interface populates a list of locations with the anticipated order delivery time and distance, which options may be received from the user device 100, transactional system 120, and/or a third-party system as described herein. Such an interface can be used to order checks, cash, food, other products, or any other transaction type that may include interacting with a physical establishment premises. Upon selection of a bank location from the list of options, the vehicle may optionally display a confirmation 1026 of the command and begin navigating 1028 to the premises, in some instances, while tracking the location of the vehicle 1030. The location tracking 1030 may be used in some instances to generate an alert within the establishment for a teller when the user vehicle is near or within the geofence of the premises so that the checks or other transaction output can be prepared.

Upon entering a vehicle geofence of the premises of the bank location (e.g., via location tracking or another vehicle detection system 150 process), the transactional system 120 may detect the vehicle 1032 and cause the vehicle-based user device 114 interface may display instructions 1034 to a particular pneumatic tube lane. An example of such interface is shown in FIG. 12. As shown in FIG. 12, information associated with an instruction data object may be provided, including a lane number to which the driver should proceed, via the user device 100 and/or the vehicle-based user device 114. The instructions may be provided in response to the vehicle entering an establishment's geofence or otherwise being detected by a vehicle detection system.

In some embodiments, illustrated as step 1036 in FIG. 10, the vehicle detection system 150 may detect the vehicle entering the instructed lane and pulling adjacent the intended dispensing device 124 (e.g., pneumatic tube) via location detection or other sensing, such as camera based scanning of the license plate and/or VIN with the camera in a known, fixed location adjacent the dispensing device. Upon approaching the dispensing device, additional authentication procedures can be performed in some embodiments, such as execution of the driver authentication model-based authentication processes 1038 discussed herein. Upon authorization (e.g., via the passive biometric authentication process using the current vehicle sensor data objects), the system can establish 1042 a secure session 1040 with the user. In the depicted embodiment, the transactional system 120 may request, via the vehicle-based user device 114 and/or user device 100, a user to input the current lane and/or a PIN number as further confirmation that the user is in the intended location.

The user can then obtain the physical transaction output (e.g., checks in the present example) from a dispensing device 124 (e.g., pneumatic tube) 1046 and the transaction may end 1048 closing the secure session.

At one or more points during the transaction process, the user may be authenticated, in some instances, passively without any input required from the driver, and the physical transaction output can then be dispensed as discussed herein according to example embodiments. In some embodiments, the dispensing device 124 may automatically provide the transaction output to the user or the dispensing device 124 may be manually or semi-automatically triggered (e.g., via user interaction directly with the dispensing device, with the user device 100, and/or with the vehicle-based user device 114) to output the transaction output. In various embodiments, the dispensing device 124 may transmit a signal within the transactional system 120 to confirm when the user has retrieved the transaction output, which may cause the transactional system to terminate the secure session.

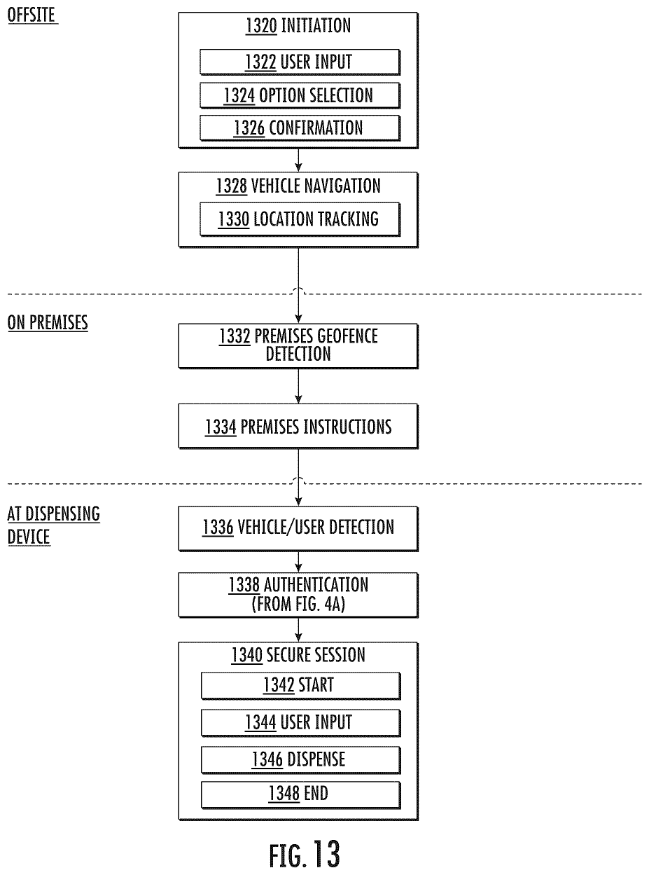

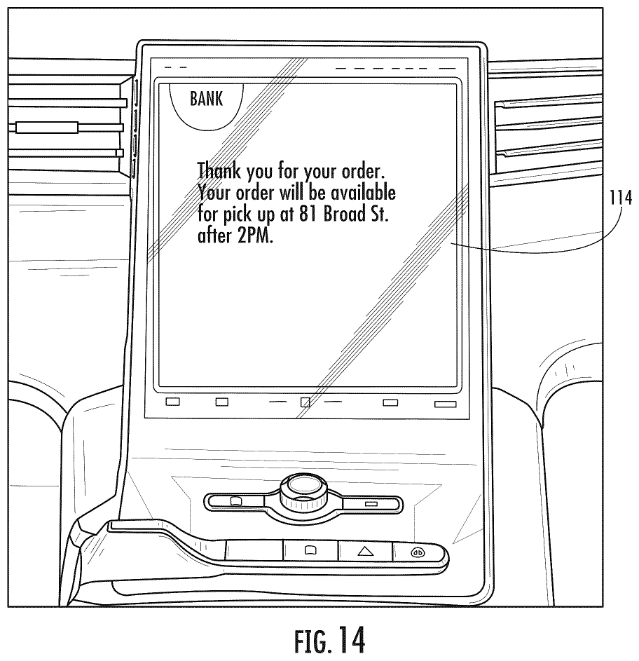

Turning to FIG. 13, another non-limiting example transaction flow is provided illustrating an example locker-based transaction. Initially, the user may be in her vehicle and may initiate 1320 a transaction via the vehicle's vehicle-based user interface 114 communicating with the user's mobile device 102 (e.g., via APPLE CARPLAY or ANDROID AUTO). The user may initially use the vehicle's voice control to input a command 1322 such as “Please order thirty dollars in quarters to be picked up this evening”. The vehicle may, in some embodiments, display a list of options 1324 such as nearby bank locations, teller hours, order delivery time, and/or distance. In some embodiments, the user may choose a locker-based option (e.g., if a desired pickup time is after hours) or the transactional system 120 may require a locker-based option for certain transaction types and/or timing requirements. Upon selection of an establishment location and/or timing, the vehicle may optionally display a confirmation 1326 of the command. An example confirmation 1326 is shown in the illustrated interface of FIG. 14. FIG. 14 provides another example of information associated with an instruction data object that can be displayed via the vehicle-based user device 114. In the depicted embodiment, after a user selects a convenient location, such as from a presented list (e.g., similar to FIG. 11), and/or otherwise initiates a transaction from any location, and the vehicle-based user device 114 may be configured to provide information relevant to the completion of the transaction, which as depicted indicates when the order will be available for pick up. Referring back to FIG. 13, upon a subsequent selection by the user and/or at a predetermined time (e.g., at a time when the time difference between the current time and a chosen pickup time is greater than or equal to the driving time from a current location to the intended establishment location), the user device 100 and/or vehicle-based user device 114 may begin navigating 1328 to the premises, in some instances, while tracking the location of the vehicle 1330.

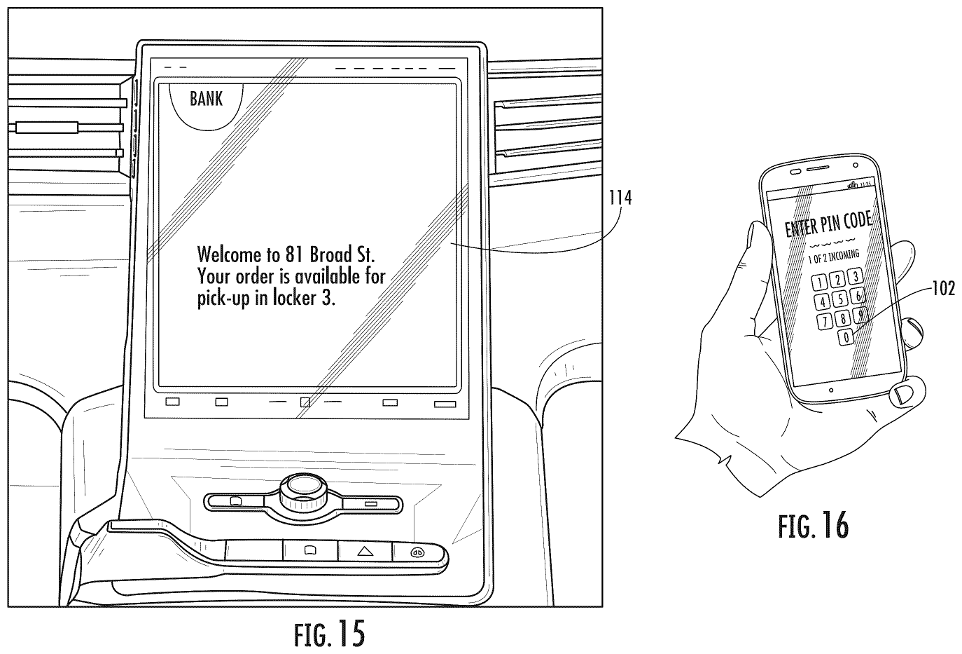

With continued reference to FIG. 13, the transactional system 120 may detect arrival of the vehicle within the geofence of the premises of the establishment 1332 and cause the display of instructions 1334 to the user indicating a dispensing device 124 to which the user should proceed. FIG. 15 illustrates an example of such an interface. In particular, FIG. 15 provides another example of information associated with an instruction data object, indicating a locker number for pickup and triggered, for example, based on a geofence or other output (e.g., a vehicle detection system 150 output).

The user may park the vehicle in a designated spot or otherwise close to the dispensing device 124 location. After parking, the user may approach the locker and the transactional system 120 may detect the user's presence at the locker 1336. For example, referring to FIG. 15, instructions are transmitted to the user for pick-up and completion of the transaction, for example, using a locker style dispensing device or another dispensing device. To retrieve the transaction output (e.g., goods, currency, etc.) from the locker, the user may use a mobile device 102 to scan a QR code at a locker, a type a code at the locker, or verify the user's presence via proximity-based sensing device (e.g., NFC or UWB connection) or another technique 1336. In some embodiments, the transaction may include authentication procedures 1338 can be performed as described herein, such as applying current vehicle data objects from an instance in which the user is in the vehicle to authenticate the user using the driver authentication model.

Referring to FIG. 13, after initial authentication, the transactional system 120 may establish a secure session 1340 with the user device 100 and/or vehicle-based user device 114 for finishing the transaction. For example, after initiating the secure session 1340, the user may provide additional input 1344, such as entering a PIN on a mobile device as shown in FIG. 16, which may complete the transaction and, in some embodiments, trigger the locker to open to dispense 1346 the quarters once the user has securely completed the transaction and been verified as present at the locker (e.g., via direct electronic communication with the locker or via a wider network). At least after the locker is opened, the secure session may end 1348. Numerous variations, including operations described herein, can be contemplated. Various triggers to initiate operations or data flows as described herein can be contemplated. For example, example embodiments a user might initially engage with a mobile device 102 or vehicle-based user device 114. As another example, a location tracker of the vehicle system 110 or mobile device 102 may trigger certain operations to be performed, as a vehicle navigates toward, or arrives at an establishment, for example.

The present embodiment contemplates performing the driver authentication model analysis on the current vehicle sensor data objects at a time when the user is no longer in the vehicle (e.g., standing in front of a locker). In some such instances, the driver authentication apparatus 160 may input and/or the vehicle system 110 may provide the most recent vehicle sensor data objects from when the user was in the vehicle. In some embodiments, the driver authentication apparatus 160 may execute the authentication process prior to the user leaving the vehicle (e.g., after the user has entered the premises geofence and before the user has parked). Similar timing and processes may be used with any of the various embodiments herein.

In an example systems herein are used to establish the identity trifecta of: (1) who you are, (2) what you know, and (3) what you have. The vehicle being detected on-premises can be used to fulfill the what-you-have portion of identity. The most recent drive to the premises can be used to establish the who-you-are portion. Code entry (e.g., a PIN) to get into the locker and access the items can be used as the final portion: what you know. In an example, if the most recent drive is within a set amount of time, the user will be prompted for a code. If there is an issue where data is too old to be considered reliable, the customer may be required to swipe their card to fulfill a what-you-have requirement/who-you-are requirement. Data can be sent when the vehicle is within a threshold distance of a location to cover for when the customer will exit the vehicle and have an expiry for authentication of a predetermined amount of time (e.g., 15 or 30 minutes).

As another non-limiting example, in some embodiments, no offsite initiation of a transaction may be required. For example, a user may pull into a premises of an establishment, such as driving to a drive-up ATM at a bank location, and the vehicle detection system 150 associated with the transactional system 120 that controls the dispensing device 124 may detect the vehicle, such as by license plate, VIN, or other image-based recognition. Upon detecting the vehicle and associating the vehicle with a registered user or users, the transactional system 120 may transmit an authentication request data object to the driver authentication apparatus and, following an authentication indication confirming that the driver of the vehicle is the registered user, an interface may be displayed according to the various embodiments herein to receive user input and both initiate and complete a transaction.

Techniques herein may be applicable to improving technological aspects of user authentication, including but not limited to authentication in remote operating environments, which may include improvements to biometric analysis, secure communications, and multi-device process execution. The foregoing techniques may further improve digital, electronic transactions (e.g., resisting fraud, transferring financial instruments, or facilitating payments) in some applications. Although some aspects of the technology may be used in the context of processes performed by a financial institution or other business, unless otherwise explicitly stated, claimed inventions are directed to technical solutions to technical problems, including those described herein, and adjacent concepts may be provided for context purposes.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care. In some embodiments, a prompt or other request may be displayed to a user requesting authorization for data collection and processing commensurate with the use cases described in various embodiments.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The various embodiments described herein are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims. Although specific terms are employed herein, they are used in a generic and descriptive sense only and not for purposes of limitation.

1. A system comprising:
a vehicle comprising:
at least one user input device configured to receive a user input;
at least one sensor configured to generate one or more vehicle sensor data objects; and
a vehicle transceiver configured to transmit the at least one vehicle sensor data object directly or indirectly to an authentication system;
at least one driver authentication apparatus comprising one or more processors and at least one non-transitory memory having instructions that, when executed by the one or more processors, cause the one or more processors to:
receive a first identifier associated with a registered user associated with a driver and a vehicle;
receive the one or more vehicle sensor data objects associated with the registered user;
generate a driver authentication model based on the one or more vehicle sensor data objects and the first identifier associated with the registered user;
receive an authentication request data object via one or more external devices, wherein the authentication request data object comprises one or more subject user identifiers associated with one or more subject identities, including the driver;
receive one or more current vehicle sensor data objects generated by the at least one sensor of the vehicle;
generate, via the driver authentication model and based on the one or more current vehicle sensor data objects, an authentication score, the authentication score indicative of a likelihood that the one or more current vehicle sensor data objects matches the driver associated with the first identifier; and
transmit an authentication success indication in an instance in which the authentication score indicates a match between the one or more current vehicle sensor data objects matches the driver associated with the first identifier; and
at least one transactional system comprising one or more processors and at least one non-transitory memory having instructions that, when executed by the one or more processors, cause the one or more processors to:
receive an indication of the user input via the at least one user input device of the vehicle;
generate an authentication request data object based on the at least one user input;
transmit the authentication request data object to the at least one driver authentication apparatus;
receive the authentication success indication from the at least one driver authentication apparatus; and
based on the authentication success indication, causing a dispensing device to output a physical transaction output.

2. The system of claim 1, wherein, in response to the authentication success indication, the at least one transactional system is configured to apply a reduced security protocol to the transaction; and
in response to an authentication failure indication, applying a standard security protocol to a transaction, wherein the reduced security protocol comprises at least one fewer security input than the standard security protocol.

3. A system comprising one or more processors and at least one non-transitory memory having instructions that, when executed by the one or more processors, cause the one or more processors to:
receive a first identifier associated with a registered user associated with a driver and a vehicle;
receive one or more vehicle sensor data objects generated via at least one sensor of the vehicle and associated with the registered user;
generate a driver authentication model based on the one or more vehicle sensor data objects and the first identifier associated with the registered user;
receive an authentication request data object;
receive one or more current vehicle sensor data objects generated by the at least one sensor of the vehicle;
generate, via the driver authentication model and based on the one or more current vehicle sensor data objects, an authentication score, the authentication score indicative of a likelihood that the one or more current vehicle sensor data objects matches the driver associated with the first identifier; and
transmit an authentication success indication in an instance in which the authentication score indicates a match between the one or more current vehicle sensor data objects matches the driver associated with the first identifier.

4. The system according to claim 3, wherein the one or more vehicle sensor data objects are generated based on a plurality of vehicle trips, each associated with the driver.

5. The system according to claim 3, wherein the first identifier is received via a mobile device in the vehicle and wherein the instructions, that when executed by the one or more processors, further cause the one or more processors to:
generate one or more labels based at least on the first identifier received via the mobile device;
update the driver authentication model with the one or more labels; and
train the driver authentication model to generate the authentication score.

6. The system according to claim 3, wherein the instructions, that when executed by the one or more processors, further cause the one or more processors to:
generate one or more labels based at least on the one or more vehicle sensor data objects;
update the driver authentication model with the one or more labels; and
train the driver authentication model to generate the authentication score.

7. The system according to claim 3, wherein the authentication request data object comprises one or more subject user identifiers associated with one or more subject identities, including the driver.

8. The system according to claim 3, wherein the authentication request data object is received from one or more external devices comprising at least one of a transactional system device, a vehicle system device, a dispensing control system, a payment server, a terminal, a vehicle detection system, a gateway control system, or an on-premises transceiver.

9. The system according to claim 3, wherein at least one of the one or more vehicle sensor data objects or the one or more current vehicle sensor data objects comprise weight sensor data generated via a weight sensor in a seat of the vehicle.

10. The system according to claim 3, wherein at least one of the one or more vehicle sensor data objects or the one or more current vehicle sensor data objects comprise location data.

11. The system according to claim 3, wherein at least one of the one or more vehicle sensor data objects or the one or more current vehicle sensor data objects comprise at least one of acceleration data, speed data, or steering data generated by the vehicle.

12. The system according to claim 3, wherein the authentication score is generated further based on additional data received from a mobile device.

13. The system according to claim 12, wherein the additional data comprises location data received via the mobile device.

14. The system according to claim 3, wherein the authentication score is generated further based on additional data received from a vehicle detection system.

15. The system according to claim 3, wherein the system comprises the vehicle.

16. A computer-implemented method comprising:
receiving a first identifier associated with a registered user associated with a driver and a vehicle;
receiving one or more vehicle sensor data objects generated via at least one sensor of the vehicle and associated with the registered user;
generating a driver authentication model based on the one or more vehicle sensor data objects and the first identifier associated with the registered user;
receiving an authentication request data object;
receiving one or more current vehicle sensor data objects generated by the at least one sensor of the vehicle;
generating, via the driver authentication model and based on the one or more current vehicle sensor data objects, an authentication score, the authentication score indicative of a likelihood that the one or more current vehicle sensor data objects matches the driver associated with the first identifier; and
transmitting an authentication success indication in an instance in which the authentication score indicates a match between the one or more current vehicle sensor data objects matches the driver associated with the first identifier.

17. The computer-implemented method according to claim 16, wherein the one or more vehicle sensor data objects are generated based on a plurality of vehicle trips, each associated with the driver.

18. The computer-implemented method according to claim 16, wherein the first identifier is received via a mobile device in the vehicle and wherein the computer-implemented method further comprises:
generating one or more labels based at least on the first identifier received via the mobile device;
updating the driver authentication model with the one or more labels; and
training the driver authentication model to generate the authentication score.

19. The computer-implemented method according to claim 16, wherein the computer-implemented method further comprises:
generating one or more labels based at least on the one or more vehicle sensor data objects;
updating the driver authentication model with the one or more labels; and
training the driver authentication model to generate the authentication score.

20. The computer-implemented method according to claim 16, wherein the authentication request data object comprises one or more subject user identifiers associated with one or more subject identities, including the driver.

21.-59. (canceled)
